(19) United States
(12) Patent Application Publication
(10) Pub. No.: US 2025/0063424 A1
(43) Pub. Date: Feb. 20, 2025

(54) METHOD AND APPARATUS FOR PROCESSING MAC CONTROL INFORMATION IN WIRELESS COMMUNICATION SYSTEM

(71) Applicant: Samsung Electronics Co., Ltd., Gyeonggi-do (KR)

(72) Inventors: Donggun KIM, Gyeonggi-do (KR); Sangkyu BAEK, Gyeonggi-do (KR)

(21) Appl. No.: 18/724,842

(22) PCT Filed: Dec. 22, 2022
(86) PCT No.: PCT/KR2022/021101

§ 371 Date: Jun. 27, 2024

(30) Foreign Application Priority Data
Dec. 27, 2021 (KR) 10-2021-0188591

(51) Int. Cl. H04W 28/02; H04L 5/00; H04W 80/02

(52) U.S. Cl. CPC H04W 28/0273; H04L 5/0053; H04W 80/02

(57) ABSTRACT

The present disclosure relates to a 5G or 6G communication system for supporting a higher data transmission rate. The present disclosure provides a method for processing MAC control information of a base station, the method comprising the steps of: identifying capability information or configuration information of a terminal; determining, on the basis of the result of the identification, whether to use a first type of MAC control information or a second type of MAC control information; generating, on the basis of the result of the determination, the first type of MAC control information or the second type of MAC control information; and transmitting, to the terminal, the first type of MAC control information or the second type of MAC control information that has been generated.

### TECHNICAL FIELD

The disclosure relates to a method and device for effectively processing pieces of MAC control information that activate or deactivate multiple RLC layer devices, to which a packet duplication technology is applied, in a system supporting a highly-reliable low-latency service.

### BACKGROUND ART

To meet the demand for wireless data traffic having increased since deployment of 4G communication systems, efforts have been made to develop an improved 5G or pre-5G communication system. Therefore, the 5G communication system is also called a “beyond 4G network” communication system or a “post LTE” system.

The 5G communication system is considered to be implemented in ultrahigh frequency (mmWave) bands, (e.g., 60 GHz bands) so as to accomplish higher data rates. To decrease the propagation loss of the radio waves and increase the transmission distance in the ultrahigh frequency bands, beamforming, massive multiple-input multiple-output (massive MIMO), full dimensional MIMO (FD-MIMO), array antenna, an analog beam forming, and large scale antenna techniques have been discussed in the 5G communication system.

In addition, in 5G communication systems, technical development for system network improvement is under way based on advanced small cells, cloud radio access networks (RANs), ultra-dense networks, device-to-device (D2D) communication, wireless backhaul, moving network, cooperative communication, coordinated multi-points (CoMPs), reception-end interference cancellation, and the like. In the 5G system, hybrid FSK and QAM modulation (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

With the advance of wireless communication systems as described above, various services can be provided, and accordingly there is a need for schemes to effectively provide these services. In particular, there is a need for a way to effectively handle MAC control information.

### DISCLOSURE OF INVENTION

### Technical Problem

A disclosed embodiment is to provide a method and a device by which a service is effectively providable in a mobile communication system.

### Solution to Problem

A method performed by a terminal according to an embodiment of the disclosure includes receiving, from a base station, a first medium access control (MAC) control element (CE) for indicating activation or deactivation of packet data convergence protocol (PDCP) duplication for one or more data radio bearers (DRBs), and determining whether to activate or deactivate the PDCP duplication for the one or more DRBs, based on a value of bits included in the first MAC CE, wherein, in case that more than two radio link control (RLC) entities are configured in a DRB, the first MAC CE is not used.

A method performed by a base station according to an embodiment of the disclosure includes determining whether to activate or deactivate packet data convergence protocol (PDCP) duplication for one or more data radio bearers (DRBs) with respect to a terminal, and transmitting, to the terminal, a first medium access control (MAC) control element (CE) for indicating activation or deactivation of the PDCP duplication for the one or more DRBs, wherein whether to activate or deactivate the PDCP duplication for the one or more DRBs is based on a value of bits included in the first MAC CE, and in case that more than two radio link control (RLC) entities are configured in a DRB, the first MAC CE is not used.

A terminal according to an embodiment of the disclosure includes a transceiver and a controller connected to the transceiver, wherein the controller is configured to receive, from a base station, a first medium access control (MAC) control element (CE) for indicating activation or deactivation of packet data convergence protocol (PDCP) duplication for one or more data radio bearers (DRBs), and determine whether to activate or deactivate the PDCP duplication for the one or more DRBs, based on a value of bits included in the first MAC CE, and in case that more than two radio link control (RLC) entities are configured in a DRB, the first MAC CE is not used.

A base station according to an embodiment of the disclosure includes a transceiver and a controller connected to the transceiver, wherein the controller is configured to determine whether to activate or deactivate packet data convergence protocol (PDCP) duplication for one or more data radio bearers (DRBs) with respect to a terminal, and transmit, to the terminal, a first medium access control (MAC) control element (CE) for indicating activation or deactivation of the PDCP duplication for the one or more DRBs, whether to activate or deactivate the PDCP duplication for the one or more DRBs is based on a value of bits included in the first MAC CE, and in case that more than two radio link control (RLC) entities are configured in a DRB, the first MAC CE is not used.

### Advantageous Effects of Invention

According to various embodiments of the disclosure, a service is effectively providable in a mobile communication system.

### BRIEF DESCRIPTION OF DRAWINGS

FIG. 1 is a diagram illustrating a structure of an LTE system according to an embodiment of the disclosure.

FIG. 2 is a diagram illustrating a radio protocol structure in an LTE system according to an embodiment of the disclosure.

FIG. 3 is a diagram illustrating a structure of a next-generation mobile communication system according to an embodiment of the disclosure.

FIG. 4 is a diagram illustrating a radio protocol structure of a next-generation mobile communication system according to an embodiment of the disclosure.

FIG. 5 is a diagram illustrating a procedure in which, in a next generation mobile communication system according to an embodiment of the disclosure, a terminal switches from a radio resource control (RRC) idle mode or RRC inactive mode to an RRC connected mode and a base station configures, for the terminal, a carrier aggregation technology, a dual connectivity technology, or a packet duplication technology;

FIG. 6 is a diagram illustrating a first protocol layer device structure for which a packet duplication technology is configured, according to an embodiment of the disclosure;

FIG. 7 illustrates first medium access control (MAC) control information proposed in the disclosure to indicate packet duplication activation or deactivation to a terminal for which a packet duplication technology or a packet duplication bearer is configured as proposed in FIG. 6, according to an embodiment of the disclosure;

FIG. 8 is a diagram illustrating a second protocol layer device structure for which a packet duplication technology is configured according to an embodiment of the disclosure;

FIG. 9 illustrates second MAC control information proposed in the disclosure to indicate packet duplication activation or deactivation to a terminal for which a packet duplication technology or a packet duplication bearer is configured as proposed in FIG. 7, according to an embodiment of the disclosure;

FIG. 10 is a diagram illustrating an operation of a base station according to an embodiment of the disclosure;

FIG. 11 illustrates a structure of a terminal according to an embodiment of the disclosure; and

FIG. 12 illustrates a configuration of a transmission and reception point (TRP) in a wireless communication system according to an embodiment of the disclosure.

### MODE FOR THE INVENTION

Hereinafter, the operation principle of the disclosure will be described in detail with reference to the accompanying drawings. In the following description of the disclosure, detailed descriptions of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

In the following description of the disclosure, detailed descriptions of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, terms and names defined in in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may indicate “gNB”.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited thereto.

In particular, the disclosure may be applied to 3GPP NR (5th generation mobile communication standard). The disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may indicate “gNB”. Also, the term “terminal” may refer to mobile phones, NB-IoT devices, sensors, and other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (or eNode B), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a communication system subsequent to LTE, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs, for example, 1,000,000 UEs/km2, in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are only examples of different types of services, and service types to which the disclosure is applicable are not limited to the above-described examples.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

In a next generation mobile communication system, in order to support a service having a high data rate and a low transmission delay, a base station needs to quickly configure a carrier aggregation (CA) technology or a dual connectivity (DC) technology for a terminal. Moreover, in order to support a service (e.g., industrial IoT (IIoT)) having a higher reliability and a lower transmission delay, a packet duplication technology may be configured and used, and the carrier aggregation technology and the dual connectivity technology may be configured and used together with the packet duplication technology. In addition, a method of additionally transmitting two or more pieces of duplicated data for one piece of data by expanding the principle of additionally transmitting one piece of duplicated data for one piece of data so as to increase reliability in the packet duplication technology may be required. Furthermore, dynamically controllable signaling may be needed so that transmission of zero, one, two, or three pieces of duplicated data is dynamically possible in some cases.

The disclosure proposes a method of additionally transmitting multiple pieces (e.g., up to three pieces) of duplicated data for one piece of data by expanding the principle of additionally transmitting one piece of duplicated data for one piece of data so as to increase reliability in a packet duplication technology. In addition, the disclosure proposes dynamically controllable signaling enabling zero, one, two, or three pieces of duplicated data to be dynamically transmitted in some cases, rather than transmitting one or three pieces of duplicated data. The signaling may be indicated by different pieces of MAC control information, the pieces of MAC control information are proposed, and methods for effectively using the proposed pieces of MAC control information are proposed, so that the complexity in implementation of a terminal or a base station is reduced and fast data processing is possible.

The disclosure considers a terminal for which a carrier aggregation technology (CA), a dual connectivity technology (DC), or a packet duplication technology is configured, and specifies a proposed method by using the terms as follows.
Primary cell (Pcell): This indicates a serving cell used by a terminal when initially configuring a connection with a base station, and the terminal may configure the connection by transmitting or receiving a major RRC message by using a Pcell. In addition, a Pcell always has physical uplink control channel (PUCCH) transmission resources and thus may indicate a hybrid automatic repeat request (HARQ) acknowledgement (ACK) or negative ACK (NACK), both uplink and downlink are always configured therein, and a Pcell may be used as a reference cell for timing adjustment (timing advance, primary timing advance group (pTAG)). For example, in a case where a Pcell is configured and then a carrier aggregation technology is configured and thus a secondary cell (Scell) is added, the Scell may perform uplink data transmission by referring to a timing adjustment value of the Pcell. If a dual connectivity technology is configured, a Pcell may indicate a Pcell of a master cell group (MCG).
Master cell group (MCG): This denotes a serving cell configured in which a terminal initially configures a connection with a base station, or a group of cells supported by the base station, and if a dual connectivity technology is configured, major RRC messages are transmitted or received through an MCG.
Secondary cell group (SCG): This indicates a group of cells supported by another base station, wherein a terminal may configure a connection with a base station and add cells of the other base station other than an MCG, and if a dual connectivity technology is configured, a secondary cell group may be added to increase an additional data rate or efficiently support the mobility of the terminal.
Primary secondary cell (PScell): A cell corresponding a Pcell in an SCG when a terminal configures a connection with a base station and cells of another other base station other than an MCG are added and thus a dual connectivity technology is configured is called a PScell.
Secondary cell (Scell): Cells additionally configured by a base station for configuration of a carrier aggregation technology after a terminal initially configures a connection with the base station are called Scells. An Scell may have PUCCH transmission resources according to a configuration of a base station, uplink or downlink may be configured therein according to a configuration of the base station, and an Scell may be used as a reference cell for timing adjustment (timing advance, secondary timing advance group (sTAG)) according to a configuration of the base station. For example, in a case where a Pcell is configured and then a carrier aggregation technology is configured and thus Scells are added and an sTAG is configured, other Scells of the sTAG may perform uplink data transmission by referring to a timing adjustment value of a designated Scell. If a dual connectivity technology is configured for a terminal, Scells indicates Scells of an MCG except for a Pcell or Scells of an SCG except for a PScell.
Primary radio link control (RLC) layer device (primary RLC entity): If a packet duplication configuration technology is configured, multiple RLC layer devices may be configured in one packet data convergence protocol (PDCP) layer device, and one RLC layer device, among the multiple RLC layer devices, which is always used without being deactivated is called a primary RLC layer device. In addition, a PDCP layer device does not overlappingly transmit a PDCP control protocol data unit (PDU) and may always transmit same to a primary RLC layer device.
Secondary RLC layer device (secondary RLC entity): If a packet duplication configuration technology is configured, multiple RLC layer devices may be configured in one PDCP layer device, and RLC layer devices remaining after excluding a primary RLC layer device from the multiple RLC layer devices are called secondary RLC layer devices.

The disclosure proposes a method enabling transmission of 0, 1, 2, or 3 duplicated packets so as to increase reliability or lower a transmission delay for a terminal for which a carrier aggregation technology (CA), a dual connectivity technology (DC), or a packet duplication technology is configured. That is, the disclosure proposes a method enabling transmission one piece of original data and a maximum of 3 pieces of duplicated data when the data is transmitted.

In the disclosure, a packet duplication technology may be configured for a terminal by a base station through an RRC message by applying a dual connectivity technology or a carrier dual connectivity technology, and specifically, the base station may configure multiple RLC layer devices connected to one MAC layer device and configure the multiple RLC layer devices to be connected to one PDCP layer device and to perform packet duplication. As another method, multiple RLC layer devices connected to one MCG MAC layer device may be configured, multiple RLC layer devices connected to one SCG MAC layer device may also be configured, and the multiple RLC layer devices connected to the different MAC layer devices may be configured to be connected to one PDCP layer device and configured to perform packet duplication.

In addition, a base station may indicate, to a terminal, which RLC layer device is a primary RLC layer device or secondary RLC layer devices among multiple RLC layer devices through an RRC message by using a logical channel identifier and a bearer identifier. For example, the base station may indicate each RLC layer device configuration information and indicate a bearer identifier and a logical channel identifier corresponding to each RLC layer device through cell group configuration information.

In addition, the base station may, through bearer configuration information, indicate each PDCP layer device configuration information, indicate a bearer identifier corresponding to each PDCP layer device and, when multiple RLC layer devices are configured for the PDCP layer device or the bearer identifier, indicate a logical channel identifier corresponding to a primary RLC layer device to indicate the primary RLC layer device. Therefore, when an RRC message is received, the terminal may configure a PDCP layer device, based on a bearer identifier, configure multiple RLC layer devices corresponding to the bearer identifier to be connected to the PDCP layer device, and designate a primary RLC layer device and multiple secondary RLC layer devices.

As another method, when a base station configures, for a terminal, multiple RLC layer devices connected to one PDCP layer device through an RRC message, the base station may indicate which RLC layer device is a primary RLC layer or secondary RLC layer devices among multiple RLC layer devices by using a logical channel identifier (or Scell identifier) and a bearer identifier. For example, the base station may indicate each RLC layer device configuration information and indicate a bearer identifier and a logical channel identifier (or Scell identifier) corresponding to each RLC layer device through cell group configuration information.

In addition, the base station may, through bearer configuration information, indicate each PDCP layer device configuration information, indicate a bearer identifier corresponding to each PDCP layer device and, when multiple RLC layer devices are configured for the PDCP layer device or the bearer identifier, indicate a logical channel identifier (or Scell identifier) corresponding to a primary RLC layer device to indicate the primary RLC layer device. Therefore, when the RRC message is received, the terminal may configure a PDCP layer device, based on a bearer identifier, configure multiple RLC layer devices corresponding to the bearer identifier to be connected to the PDCP layer device, and designate a primary RLC layer device and multiple secondary RLC layer devices by using the logical channel identifier or Scell identifier.

As another method, when a base station configures, for a terminal, multiple RLC layer devices connected to one PDCP layer device through an RRC message, the base station may indicate which RLC layer device is a primary RLC layer or secondary RLC layer devices among multiple RLC layer devices by using a new identifier (an identifier, such as 0, 1, 2, or 3, indicating each RLC layer device), a bearer identifier, or a logical channel identifier.

For example, the base station may indicate each RLC layer device configuration information and indicate a bearer identifier and a logical channel identifier or a new identifier corresponding to each RLC layer device through cell group configuration information. In addition, the base station may, through bearer configuration information, indicate each PDCP layer device configuration information, indicate a bearer identifier corresponding to each PDCP layer device and, when multiple RLC layer devices are configured for the PDCP layer device or the bearer identifier, indicate a logical channel identifier or a new identifier corresponding to a primary RLC layer device to indicate the primary RLC layer device.

According to an embodiment of the disclosure, a specific value (e.g., an identifier having the lowest value, that is, 0) of a new identifier may be defined to indicate a primary RLC layer device, and RLC layer devices having other values may be defined to be secondary RLC layer devices. However, the disclosure is not limited to the above example. Therefore, when an RRC message is received, the terminal may configure a PDCP layer device, based on a bearer identifier, configure multiple RLC layer devices corresponding to the bearer identifier to be connected to the PDCP layer device, and designate a primary RLC layer device and multiple secondary RLC layer devices by using the logical channel identifier or new identifier.

When a packet duplication procedure proposed in the disclosure is applied, a structure in which one primary RLC layer device and multiple (e.g., 1, 2, or 3) secondary RLC layer devices are connected to one PDCP layer device may be used to overlappingly transmit data. Therefore, the terminal is required to distinguish between the multiple secondary RLC layer devices. It is necessary for the terminal to distinguish between secondary RLC layer devices configured in each bearer so that each of the secondary RLC layer devices may be activated or deactivated by MAC control information. Therefore, hereinafter, a method of distinguishing between secondary RLC layer devices configured in a bearer in which packet duplication is configured is proposed as follows.
Proposed method: If a new identifier (e.g., logical channel identifier, such as 0, 1, 2, or 3) is configured for each of multiple RLC layer devices connected to one PDCP layer device through an RRC message, a terminal may identify a primary RLC layer device or a secondary RLC layer device, and distinguish between secondary RLC layer devices, based on the new identifier. Alternatively, if packet duplication is configured, the terminal may activate or deactivate RLC layer devices indicated to be activated or deactivated by an RRC message or a MAC CE with respect to RLC layer devices connected to a PDCP layer device for which the packet duplication is configured. In addition, the terminal may map bitmap information of an RRC message or MAC control information in ascending order (or descending order) of a new identifier and map respective bits to secondary RLC layer devices to distinguish between the secondary RLC layer devices.

Therefore, a base station may indicate activation or deactivation for each of secondary RLC layer devices by using MAC control information (MAC CE), and when the terminal receives the RRC message or the MAC control information, the terminal may activate or deactivate a secondary RLC layer device corresponding thereto. RLC layer devices indicated to be activated or deactivated by an RRC message or a MAC CE may be allocated only to secondary RLC layer devices, the primary RLC layer device may always maintain an activated state, and the primary RLC layer device may not be deactivated. This is because, if the primary RLC layer device is maintained to be in an activated state, a PDCP layer device has an RLC layer device to which the PDCP layer device is always able to transmit data, and thus the PDCP layer device may always transmit PDCP control data to the primary RLC layer device regardless of an activated or deactivated state of a packet duplication function (e.g., if the packet duplication function is activated or deactivated), so that the complexity of implementation may be minimized.

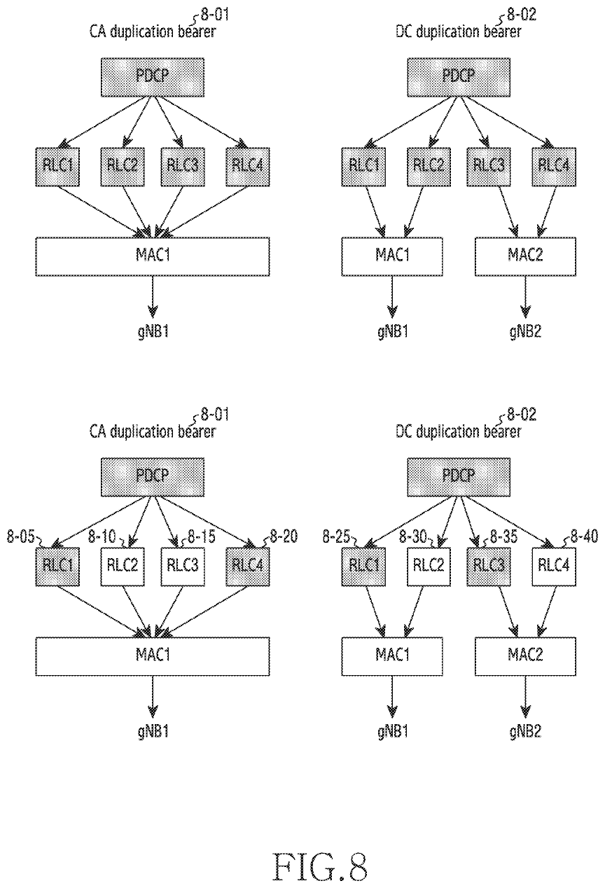

The reason why a method of distinguishing between secondary RLC layer devices is needed is that a logical channel identifier allocated to each RLC layer device is a unique identifier only in one MAC layer device. Therefore, when a dual connectivity technology is configured and a packet duplicate transmission technology is configured as indicated by reference numeral 8-02 in FIG. 8 of the disclosure, RLC layer device 1 and RLC layer device 2 are connected to one MAC layer device and thus have different logical channel identifiers, and RLC layer device 3 and RLC layer device 4 are connected to one MAC layer device and thus have different logical channel identifiers.

However, RLC layer device 1 may have the same logical channel identifier as that of RLC layer device 3 or RLC layer device 4 connected to a different MAC layer device, and RLC layer device 2 may have the same logical channel identifier as that of RLC layer device 3 or RLC layer device 4 connected to a different MAC layer device.

Therefore, secondary RLC layer devices may not be distinguishable from each other by using only a logical channel identifier. Therefore, when bitmap information of an RRC message or MAC control information are mapped to new identifiers (e.g., logical channel identifiers) of secondary RLC layer devices, secondary RLC layer devices for an MCG may be mapped in ascending order (or descending order) of a new identifier value from the least significant bit (LSB) or from the right, and then secondary RLC layer devices for an SCG may be mapped in ascending order (or descending order) of a new identifier value from the LSB or from the right.

In addition, in a case where with respect to multiple RLC layer devices connected to a PDCP layer device of a bearer in which packet duplication is configured through an RRC message, the terminal activates only one RLC layer device and deactivates all the remaining RLC layer devices (e.g., secondary RLC layer devices) due to an indication of a MAC CE, that is, an indication of activation or deactivation of each RLC layer device for the multiple RLC layer devices, the terminal may determine this case to be deactivation of packet duplication and allow a MAC layer device having received the MAC CE to indicate that a packet duplication technology has been deactivated to the PDCP layer device so that the PDCP layer device stops applying the packet duplication technology.

In addition, in a case where only one RLC layer device is activated with respect to multiple RLC layer devices, if 2 or more RLC layer devices (a primary RLC layer device and at least one secondary RLC layer device) are activated due to reception of a MAC CE, a MAC layer device having received the MAC CE may be allowed to indicate that packet duplication has been activated and indicate the activated RLC layer devices (e.g., identifiers) to a PDCP layer device so that the PDCP layer device applies the packet duplication to the activated RLC layer devices. In addition, in a case where multiple RLC layer devices connected to a PDCP

layer device of a bearer in which packet duplication is configured through an RRC message are configured, if the terminal autonomously determines which RLC layer devices to be activated (or to be used for duplicate data transmission) or deactivated (or not to be used for duplicate data transmission), based on channel measurement information of Scells mapped to the RLC layer devices, the terminal may determine a primary RLC layer device among the RLC layer devices determined to be activated and indicate, to the PDCP layer device, which RLC layer device is the primary RLC layer device or a secondary RLC layer device (or which RLC layer devices to be used for duplicate data transmission) so that the PDCP layer device correctly processes PDCP control data

In addition, in a case where only one RLC layer device is activated (or used for duplicate data transmission) among the RLC layer devices determined to be activated (or to be used for duplicate data transmission), the terminal may indicate deactivation of packet duplication to the PDCP layer device, and in a case where 2 or more RLC layer devices are activated (or used for duplicate data transmission), the terminal may indicate packet duplication activation and the activated RLC layer devices (RLC layer devices to be used for duplicate data transmission) to the PDCP layer device so that the PDCP layer device performs a packet duplication procedure corresponding thereto.

In addition, in a case where the terminal autonomously determines which RLC layer devices to be activated (or to be used for duplicate data transmission) or deactivated (or not to be used for duplicate data transmission), based on channel measurement information of Scells mapped to the RLC layer devices, the terminal may indicate, to the base station, information on the activated RLC layer devices (or RLC layer devices determined to be used for duplicate data transmission) or primary

RLC layer device or secondary RLC layer device information by using a MAC CE, an RLC control PDU, or a PDCP control PDU so as to notify the base station of information on application of a packet duplication technology by the terminal. Therefore, the base station may know which RLC layer device receives PDCP control data or which RLC layer device to which a packet duplication technology is applied.

Hereinafter, how to design a MAC CE for application of a packet duplication technology to multiple RLC layer devices described above is proposed in detail through various embodiments.

In addition, in a case where multiple RLC layer devices connected to a PDCP layer device for which a packet duplication technology proposed in the disclosure is configured are configured in the same MAC layer device and apply the packet duplication technology, based on a carrier aggregation technology (CA), each RLC layer device may have a cell mapping restriction in which RLC layer devices are mapped to different Pcells, PScells, or Scells and transmit duplicate data.

In addition, in a case where multiple RLC layer devices connected to a PDCP

layer device for which a packet duplication technology proposed in the disclosure is configured are configured in different MAC layer devices and apply the packet duplication technology, based on a dual connectivity technology (CA), each RLC layer device may have a cell mapping restriction in which RLC layer devices are mapped to different Pcells, PScells, or Scells and transmit duplicate data.

In addition, some of multiple RLC layer devices connected to a PDCP layer device for which a packet duplication technology proposed in the disclosure is configured are configured in the same MAC layer device and a packet duplication technology based on a carrier aggregation technology is applied, some of them are configured in different MAC layer devices and may apply the packet duplication technology, based on a dual connectivity technology, and each RLC layer device may have a cell mapping restriction in which RLC layer devices are mapped to different Pcells, PScells, or Scells in one MAC layer device and transmit duplicate data.

In addition, in a case where multiple RLC layer devices or some of them, the multiple RLC layer devices being connected to a PDCP layer device for which a packet duplication technology proposed in the disclosure is configured, are configured in one MAC layer device and apply the packet duplication technology, based on a carrier aggregation technology, each RLC layer device configured in the one MAC layer device may have a cell mapping restriction in which RLC layer devices are mapped to different Pcells, PScells, or Scells and transmit duplicate data.

In addition, if the packet duplication technology based on the carrier aggregation technology configured in the one MAC layer device is deactivated, the cell mapping restriction may not be applied, at the time of data transmission, to the multiple RLC layer devices connected to the MAC layer device and connected to the PDCP layer device for which the packet duplication technology is configured, and if the packet duplication technology based on the carrier aggregation technology configured in the one MAC layer device is activated, the cell mapping restriction may be applied at the time of data transmission again.

In addition, in a case where multiple RLC layer devices or some of them, the multiple RLC layer devices being connected to a PDCP layer device for which a packet duplication technology proposed in the disclosure is configured, are configured in different MAC layer devices and apply the packet duplication technology, based on a dual connectivity technology, each RLC layer device configured in the different MAC layer devices may have a cell mapping restriction in which RLC layer devices are mapped to different Pcells, PScells, or Scells and transmit duplicate data. Even if the packet duplication technology based on the dual connectivity technology configured in the different MAC layer devices is deactivated, the cell mapping restriction may be continuously applied, at the time of data transmission, to the multiple RLC layer devices connected to the different MAC layer devices and connected to the PDCP layer device for which the packet duplication technology is configured.

For example, with respect to RLC layer device 1, RLC layer device 2, RLC layer device 3, and RLC layer device 4 connected to a PDCP layer device for which a packet duplication technology is configured, it may be assumed that RLC layer device 1 and RLC layer device 2 are connected to MAC layer device 1 and RLC layer device 3 and RLC layer device 4 are connected to MAC layer device 2. A cell mapping restriction may be configured for the RLC layer devices with respect to each MAC layer device.

If packet duplication is performed based on a carrier aggregation technology through MAC layer device 1 by using RLC layer device 1 and RLC layer device 2, a cell mapping restriction configuration for RLC layer device 1 and RLC layer device 2 may be applied. However, when the packet duplication based on the carrier aggregation technology is deactivated, the terminal may not apply the cell mapping restriction configuration to RLC layer device 1 and RLC layer device 2

In addition, if packet duplication is performed based on a dual connectivity technology through MAC layer device 2 by using RLC layer device 1 and RLC layer device 3, a cell mapping restriction configuration for RLC layer device 1 and RLC layer device 3 may be applied. However, even when packet duplication based on a carrier aggregation technology is deactivated, the terminal may continuously apply the cell mapping restriction configuration to RLC layer device 1 and RLC layer device 2. This is because different MAC layer devices already have multiplexing gain if it is possible to configure the devices to have different frequencies.

Therefore, if packet duplication is performed based on a carrier aggregation technology through MAC layer device 1 by using RLC layer device 1 and RLC layer device 2 and, simultaneously, packet duplication is performed based on a dual connectivity technology through MAC layer device 2 by using RLC layer device 3, a cell mapping restriction configuration for RLC layer device 1, RLC layer device 2, and RLC layer device 3 may be applied. However, when the packet duplication based on the carrier aggregation technology and the dual connectivity technology is deactivated, the terminal may not apply the cell mapping restriction configuration to RLC layer device 1 and RLC layer device 2 and may continuously apply the cell mapping restriction configuration to RLC layer device 3.

In the disclosure, an embodiment in which one primary RLC layer device is configured and a maximum of 3 secondary RLC layer devices are configurable is described for convenience of explanation. However, embodiments proposed in the disclosure may be applied after being expanded to embodiments in which one or multiple primary RLC layer devices or secondary RLC layer devices are configured.

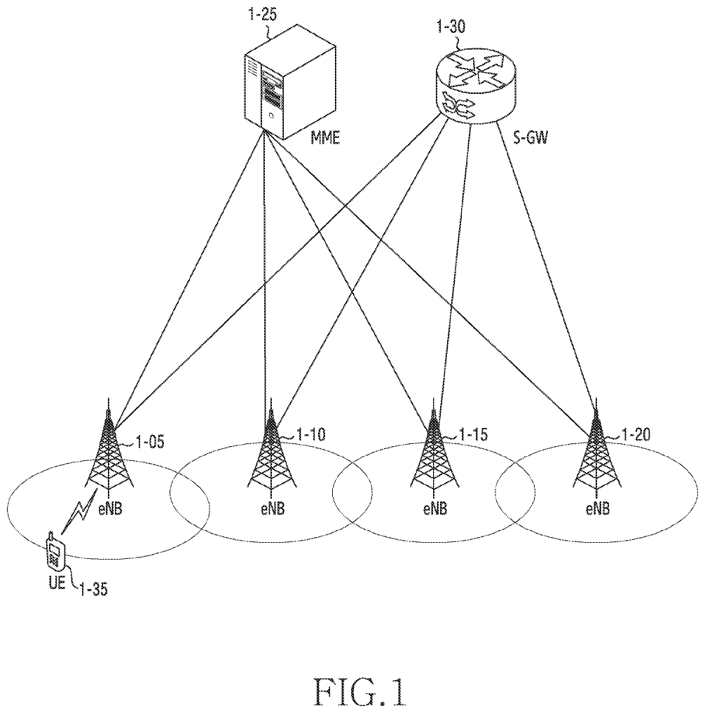

FIG. 1 illustrates a structure of an LTE system according to an embodiment of the disclosure.

Referring to FIG. 1a, as illustrated therein, a radio access network of an LTE system includes next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 accesses an external network through the ENBs 1-05 to 1-20 and the S-GW 1-30.

In FIG. 1, the ENBs 1-05 to 1-20 may correspond to conventional node Bs of a universal mobile telecommunication system (UMTS). The ENBs may be connected to the UE 1-35 through a radio channel, and perform more complicated roles than the conventional node Bs. In the LTE system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the ENBs 1-05 to 1-20 may serve as the device. In general, one ENB controls multiple cells. For example, in order to implement a transfer rate of 100 Mbps, the LTE system may use orthogonal frequency division multiplexing (OFDM) as a radio access technology in a bandwidth of, for example, 20 MHz. Of course, examples of the radio access technology are not limited thereto. Furthermore, the ENBs 1-05 to 1-20 may employ an adaptive modulation & coding (AMC) scheme for determining a modulation scheme and a channel coding rate according to a channel state of the UE. The S-GW 1-30 is a device that provides a data bearer, and generates or removes a data bearer under the control of the MME 1-25. The MME 1-25 is responsible for various control functions as well as a mobility management function for the UE, and is connected to multiple base stations.

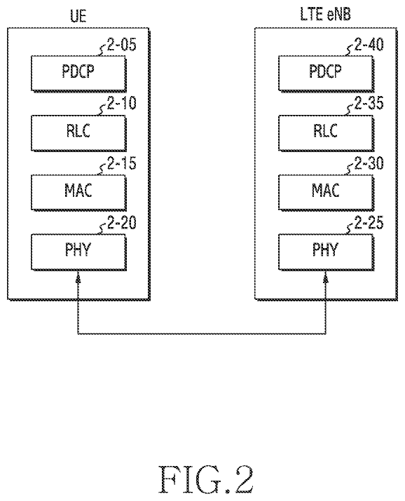

FIG. 2 illustrates a radio protocol structure in an LTE system according to an embodiment of the disclosure.

Referring to FIG. 2, a radio access protocol of an LTE system may include a PDCP 2-05 or 2-40, an RLC 2-10 or 2-35, and an MAC 2-15 or 2-30 in each of a UE and an ENB. The PDCP 2-05 or 2-40 may serve to perform operations, such as IP header compression/reconstruction. The main functions of the PDCP are summarized as follows. Obviously, the example given below is not limiting.
Header compression and decompression: robust header compression (ROHC) only
Transfer of user data
In-sequence delivery of upper layer PDUs at PDCP re-establishment procedure for RLC acknowledged mode (AM)
For split bearers in DC (only support for RLC AM): PDCP PDU routing for transmission and PDCP PDU reordering for reception)
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 2-10 or 2-35 may reconfigure a PDCP protocol data unit (PDU) or an RLC service data unit (SDU) to have a proper size to perform an ARQ operation. The main functions of the RLC are summarized as follows. Obviously, the example given below is not limiting.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and multiplex RLC PDUs into a MAC PDU and demultiplex a MAC PDU into RLC PDUs. The main functions of the MAC are summarized as follows. Obviously, the example given below is not limiting.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
Multimedia broadcast and multicast service (MBMS) service identification
Transport format selection
Padding

A physical layer 2-20 or 2-25 may perform operations of channel-coding and modulating upper layer data, generating the same into OFDM symbols, and transmitting the same through a radio channel, or demodulating the OFDM symbols received through the radio channel, channel-decoding the same, and delivering the same to the upper layer. Of course, examples of the operations are not limited thereto.

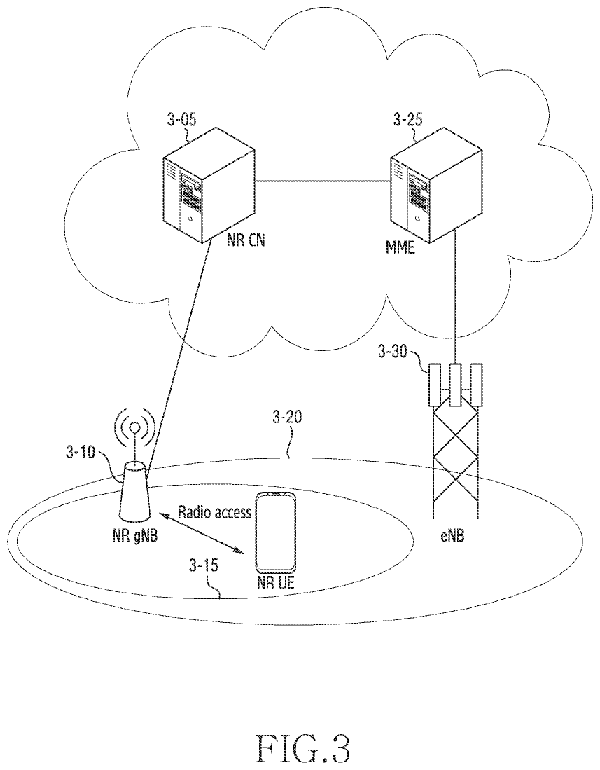

FIG. 3 illustrates a structure of a next-generation mobile communication system according to an embodiment of the disclosure.

Referring to FIG. 3, a radio access network of a next-generation mobile communication system (hereinafter NR or 5G) may include a next-generation base station (new radio node B, hereinafter NR gNB or NR base station) 3-10, and a new radio core network (NR CN) 3-05. A user equipment (new radio user equipment, hereinafter NR UE or NR terminal) 3-15 may access an external network via the NR gNB 3-10 and the NR CN 3-05.

In FIG. 3, the NR gNB 3-10 may correspond to an evolved node B (eNB) of a conventional LTE system. The NR gNB 3-10 may be connected to the NR UE 3-15 through a radio channel and provide outstanding services as compared to a conventional node B. In the next-generation mobile communication system, since all user traffic is serviced through a shared channel, a device that collects state information, such as buffer statuses, available transmit power states, and channel states of UEs, and performs scheduling accordingly is required, and the NR gNB 3-10 may serve as the device. In general, one NR gNB 3-10 controls multiple cells.

In order to implement data transmission with an ultrahigh speed compared to the current LTE, the next-generation mobile communication system may have a bandwidth wider than the existing maximum bandwidth, may employ an orthogonal frequency division multiplexing (OFDM) as a wireless access technology, and may additionally use a beamforming technology. Furthermore, according to an embodiment, the NR gNB 3-10 may employ an adaptive modulation & coding (AMC) scheme for determining a modulation scheme and a channel coding rate according to a channel state of the UE. The NR CN 3-05 may perform functions such as mobility support, bearer configuration, and QoS configuration. The NR CN is a device responsible for various control functions, as well as a mobility management function for the UE, and may be connected to multiple base stations. In addition, the next-generation mobile communication system may interwork with the existing LTE system, and the NR CN may be connected to an MME 3-25 via a network interface. The MME may be connected to an eNB 3-30 that is an existing base station.

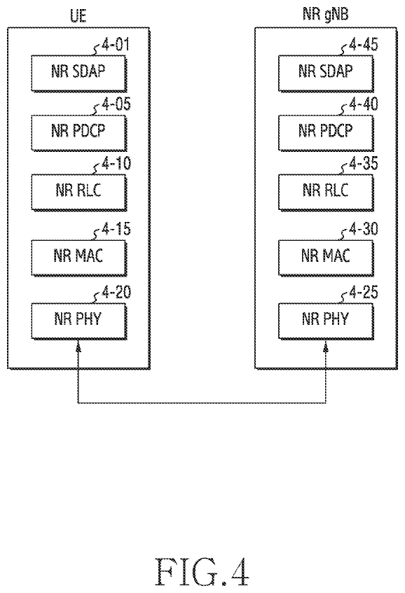

FIG. 4 illustrates a radio protocol structure of a next-generation mobile communication system to which the disclosure is applicable.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, and an NR MAC 4-15 or 4-30 in each of an NR UE and an NR base station.

According to an embodiment of the disclosure, the main functions of the NR SDAP 4-01 or 4-45 may include some of functions below. Obviously, the example given below is not limiting.
Transfer of user plane data
Mapping between a QoS flow and a data bearer for uplink and downlink (mapping between a QoS flow and a DRB for both DL and UL)
Marking QoS flow ID in both DL and UL packets
Reflective QoS flow to DRB mapping for UL SDAP PDUs

Whether to use a header of the SDAP layer device, or whether to use a function of the SDAP layer device may be configured for the UE with respect to the SDAP layer device through an RRC message for each PDCP layer device, each bearer, or each logical channel. In a case where an SDAP header is configured, an NAS QoS reflective configuration one-bit indicator (non-access stratum (NAS) reflective QoS) and an As QoS reflective configuration one-bit indicator (AS reflective QoS) of the SDAP header may indicate the UE to update or reconfigure mapping information relating to a QoS flow and a data bearer for uplink and downlink. The SDAP header may include QoS flow ID information indicating the QoS. The QoS information may be used as data processing priority, scheduling information, or etc. for smoothly supporting the service.

According to an embodiment of the disclosure, the main functions of the NR PDCP 4-05 or 4-40 may include some of functions below. Obviously, the example given below is not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

According to an embodiment of the disclosure, the reordering of the NR PDCP device may refer to a function of reordering PDCP PDU received from a lower layer in an order based on PDCP sequence numbers (SNs). The reordering of the NR PDCP device may include at least one of a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

According to an embodiment of the disclosure, the main functions of the NR RLC 4-10 or 4-35 may include some of functions below. Obviously, the example given below is not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

According to an embodiment of the disclosure, the in-sequence delivery of the NR RLC device may refer to a function of successively delivering RLC SDUs received from the lower layer to the upper layer. The in-sequence delivery may include at least one of a function of, if one original RLC SDU is divided into several RLC SDUs and then the RLC SDUs are received, reassembling the several RLC SDUs and transferring the reassembled RLC SDUs, a function of rearranging received RLC PDUs with reference to RLC sequence numbers (SNs) or PDCP sequence numbers (SNs), a function of rearranging order to record lost RLC PDUs, a function of reporting the state of lost RLC PDUs to a transmission side, a function of requesting retransmission of lost RLC PDUs, a function of, if there is a lost RLC SDU, sequentially transferring only RLC SDUs before the lost RLC SDU to an upper layer, a function of, although there is a lost RLC SDU, if a predetermined timer has expired, sequentially transferring, to an upper layer, all the RLC SDUs received before the timer is started, and a function of, although there is a lost RLC SDU, if a predetermined timer has expired, sequentially transferring all the RLC SDUs received up to now, to an upper layer.

In addition, according to an embodiment of the disclosure, the NR RLC 4-10 or 4-35 may process the RLC PDUs in the received order (regardless of the sequence number order, in the order of arrival) and deliver the same to the PDCP device regardless of the order (out-of-sequence delivery), and in the case of segments, may receive segments which are stored in a buffer or which are to be received later, reconfigure the same into one complete RLC PDU, process the same, and deliver the same to the PDCP device. The NR RLC 4-10 or 4-35 may include no concatenation function, which may be performed in the NR MAC layer or replaced with a multiplexing function of the NR MAC layer.

The out-of-sequence delivery of the NR RLC device 4-10 or 4-35 may include a function of directly delivering RLC SDUs received from a lower layer to an upper layer regardless of the order, and may include at least one of a function of reassembling and delivering multiple RLC SDUs received, into which one original RLC SDU has been segmented, and a function of storing and reordering the RLC SNs or PDCP SNs of received RLC PDUs and recording lost RLC PDUs.

The NR MAC 4-15 or 4-30 may be connected to multiple NR RLC layer devices configured in one UE, and the main functions of the NR MAC may include some of functions below. Obviously, the example given below is not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, an NR PHY layer 4-20 or 4-25 may perform operations of channel-coding and modulating upper layer data, generating the same into OFDM symbols, and transmitting the same through a radio channel, or demodulating OFDM symbols received through the radio channel, channel-decoding the same, and delivering the same to the upper layer. Obviously, the example given below is not limiting.

In the disclosure, a bearer may have the meaning including a signaling radio bearer (SRB) and a data radio bearer (DRB), an SRB denotes a signaling radio bearer, and a DRB denotes a data radio bearer. A UM DRB indicates a DRB using an RLC layer device operating in an unacknowledged mode (UM) mode, and an AM DRB may indicate a DRB using an RLC layer device operating in an acknowledged mode (AM) mode. SRB0 is an unencrypted SRB and denotes a bearer which is configured for an MCG of a terminal and through which a base station and the terminal transmit or receive an RRC message, SRB1 is an encrypted SRB and denotes a bearer which is configured for an MCG of a terminal and through which a base station and the terminal transmit or receive an RRC message configuring a major connection, SRB2 is an encrypted SRB and denotes a bearer which is configured for an MCG of a terminal and through which a base station and the terminal configure a connection and transmit or receive a NAS-related RRC message, and SRB3 is an encrypted SRB and may denote a bearer which is configured for an SCG of a terminal and through which the terminal is able to directly transmit an RRC message to an MCG through an SCG MAC layer device. A split SRB may denote an SRB wherein one PDCP layer device is present in an MCG or SCG, two RLC layer devices are connected to the one PDCP layer device and perform data transmission or reception, one RLC layer device is connected to an MCG MAC layer device, and the other RLC layer device is connected to an SCG MAC layer device.

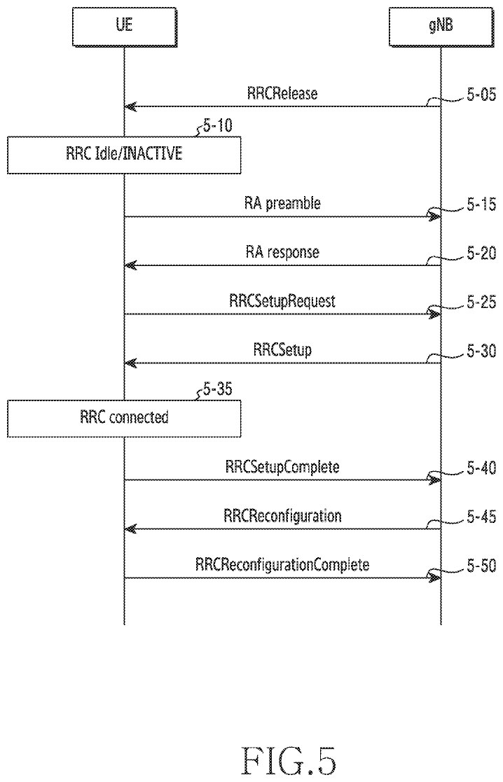

FIG. 5 is a diagram illustrating a procedure in which, in a next generation mobile communication system according to an embodiment of the disclosure, a terminal switches from a RRC idle mode or RRC inactive mode to an RRC connected mode and a base station configures, for the terminal, a carrier aggregation technology, a dual connectivity technology, or a packet duplication technology.

In FIG. 5, a base station may transition an RRC connected mode terminal, which has established a connection with a network, to an RRC idle mode or an RRC inactive mode for a predetermined reason. The predetermined reason may include lack of scheduling resources of the base station or suspension of data transmission and reception with the terminal for a predetermined time.

The base station may transmit an RRCRelease message to the terminal to instruct the terminal to transition to an RRC idle mode or an RRC inactive mode. The base station may instruct the terminal to transition to an RRC inactive mode by using an indicator (e.g., suspend-config) in the RRCRelease message, and if the RRCRelease message does not include the indicator (e.g., suspend-config), the terminal may transition to an RRC idle mode (operation 5-05).

The terminal having transitioned the RRC idle mode or RRC inactive mode may, when the terminal needs to connect to the network for a predetermined reason, perform a random access procedure, receive a random access response, request RRC connection establishment, and receive an RRC message to perform RRC connection establishment (operations 5-10, 5-15, 5-20, 5-25, 5-30, 5-35, and 5-40).

The terminal may establish a reverse transmission synchronization with the base station through a random access process, and transmit an RRCSetupRequest message or an RRCResumeRequest message (in a case of the terminal in the RRC inactive mode) to the base station (operation 5-25). The RRCSetupRequest message or RRCResumeRequest message (in a case of the terminal in the RRC inactive mode) may include an identifier of the terminal and a reason (establishmentCause) to establish the connection.

The base station may transmit an RRCSetup message or RRCResume message (in a case of the terminal in the RRC inactive mode) to the terminal to establish an RRC connection (operation 5-30). The RRCSetup message or RRCResume message (in a case of the terminal in the RRC inactive mode) may include at least one of configuration information for each logical channel, configuration information for each bearer, configuration information of a PDCP layer device, configuration information of an RLC layer device, and configuration information of a MAC layer device.

The RRCSetup message or RRCResume message (in a case of the terminal in the RRC inactive mode) may assign a bearer identifier (e.g., an SRB identifier or DRB identifier) to each bearer and indicate a configuration of a PDCP layer device, an RLC layer device, a MAC layer device, and a PHY layer device for each bearer. In addition, the RRCSetup message or RRCResume message (in a case of the terminal in the RRC inactive mode) may configure a packet duplicate transmission technology.

Specifically, a packet duplication technology may be configured for the terminal by the base station through an RRC message by applying a dual connectivity technology or a carrier dual connectivity technology. Specifically, the terminal may configure multiple RLC layer devices connected to one MAC layer device and may configure the multiple RLC layer devices to be connected to one PDCP layer device and to perform packet duplication. As another method, the terminal may configure multiple RLC layer devices connected to one MCG MAC layer device, also configure multiple RLC layer devices connected to one SCG MAC layer device, configure the multiple RLC layer devices connected to the different MAC layer devices to be connected to one PDCP layer device and to perform packet duplication.

In addition, the base station may indicate, to the terminal, which RLC layer device is a primary RLC layer device or secondary RLC layer devices among multiple RLC layer devices through an RRC message by using a logical channel identifier and a bearer identifier. For example, the base station may indicate each RLC layer device configuration information and indicate a bearer identifier and a logical channel identifier corresponding to each RLC layer device through cell group configuration information.

In addition, the base station may, through bearer configuration information, indicate each PDCP layer device configuration information, indicate a bearer identifier corresponding to each PDCP layer device and, when multiple RLC layer devices are configured for the terminal for the PDCP layer device or the bearer identifier, the base station may indicate a logical channel identifier corresponding to a primary RLC layer device to indicate the primary RLC layer device. Therefore, when an RRC message is received, a terminal may configure a PDCP layer device, based on a bearer identifier, configure multiple RLC layer devices corresponding to the bearer identifier to be connected to the PDCP layer device, and designate a primary RLC layer device and multiple secondary RLC layer devices.

As another method, when the base station configures, for the terminal, multiple RLC layer devices connected to one PDCP layer device through an RRC message, the base station may indicate which RLC layer device is a primary RLC layer or secondary RLC layer devices among multiple RLC layer devices by using a logical channel identifier (or Scell identifier) and a bearer identifier. For example, the base station may indicate each RLC layer device configuration information and indicate a bearer identifier and a logical channel identifier (or Scell identifier) corresponding to each RLC layer device through cell group configuration information.

In addition, the base station may, through bearer configuration information, indicate each PDCP layer device configuration information, indicate a bearer identifier corresponding to each PDCP layer device and, when multiple RLC layer devices are configured for the terminal for the PDCP layer device or the bearer identifier, the base station may indicate a logical channel identifier (or Scell identifier) corresponding to a primary RLC layer device to indicate the primary RLC layer device. Therefore, when the RRC message is received, the terminal may configure a PDCP layer device, based on a bearer identifier, configure multiple RLC layer devices corresponding to the bearer identifier to be connected to the PDCP layer device, and designate a primary RLC layer device and multiple secondary RLC layer devices by using the logical channel identifier or Scell identifier.

In addition, if a new identifier (e.g., logical channel identifier, such as 0, 1, 2, or 3) is configured for each of multiple RLC layer devices connected to one PDCP layer device through an RRC message, the terminal may identify a primary RLC layer device or a secondary RLC layer device, and distinguish between secondary RLC layer devices, based on the new identifier. Alternatively, if packet duplication is configured, the terminal may activate or deactivate RLC layer devices indicated to be activated or deactivated by an RRC message or a MAC CE with respect to RLC layer devices connected to a PDCP layer device for which the packet duplication is configured. The terminal may map bitmap information of an RRC message or MAC control information in ascending order (or descending order) of the new identifier and map respective bits to secondary RLC layer devices to distinguish between the secondary RLC layer devices.

Therefore, the base station may indicate activation or deactivation for each of secondary RLC layer devices by using MAC control information (MAC CE), and when the terminal receives the RRC message or the MAC control information, the terminal may activate or deactivate a secondary RLC layer device corresponding thereto. RLC layer devices indicated to be activated or deactivated by an RRC message or a MAC CE may be allocated only to secondary RLC layer devices, the primary RLC layer device may always maintain an activated state, and the primary RLC layer device may not be deactivated. This is because, if the primary RLC layer device is maintained to be in an activated state, a PDCP layer device has an RLC layer device to which the PDCP layer device is always able to transmit data, and thus the PDCP layer device may always transmit PDCP control data to the primary RLC layer device regardless of an activated or deactivated state of a packet duplication function (e.g., if the packet duplication function is activated or deactivated), so that the complexity of implementation may be minimized.

The terminal having established the RRC connection may transmit an RRCSetupComplete message or RRCResumeComplete message (in a case of the terminal in the RRC inactive mode) to the base station (operation 5-40). The RRCSetupComplete message or RRCResumeComplete message (in a case of the terminal in the RRC inactive mode) may include a control message, called SERVICE REQUEST, through which the terminal requests bearer configuration for a predetermined service from an AMF or MME. The base station may transmit a SERVICE REQUEST message included in an RRCConnectionSetupComplete message or RRCResumeComplete message (in a case of the terminal in the RRC inactive mode) to an access and mobility management function (AMF) or a mobility management entity (MME), and the AMF or MME may determine whether to provide the service requested by the terminal.

If a result of the determination shows that the AMF or MME has decided to

provide the service requested by the terminal, the AMF or MME transmits an INITIAL CONTEXT SETUP REQUEST message to the base station. The INITIAL CONTEXT SETUP REQUEST message may include information, such as QoS information to be applied at the time of DRB configuration, and security-related information (e.g., a security key or a security algorithm) to be applied to the DRB.

When the base station transmits or receives a Security ModeCommand message and a Security ModeComplete message to or from the terminal to configure security and then the security configuration is completed, the base station may transmit an RRCConnectionReconfiguration message to the terminal (operation 5-45).

The RRCConnectionReconfiguration message may assign a bearer identifier (e.g., an SRB identifier or DRB identifier) to each bearer and indicate a configuration of a PDCP layer device, an RLC layer device, a MAC layer device, and a PHY layer device for each bearer.

In addition, the RRCConnectionReconfiguration message may configure additional Scells to configure a carrier aggregation technology for the terminal, or configure additional SCG configuration information to configure a dual connectivity technology.

In addition, the RRCConnectionReconfiguration message may include configuration information of a DRB through which user data is to be processed, and the terminal may apply the configuration information of the DRB through which the user data is to be processed, to configure the DRB and transmit an RRCConnectionReconfigurationComplete message to the base station (operation 5-50). The base station having completed DRB configuration with the terminal may transmit an INITIAL CONTEXT SETUP COMPLETE message to the AMF or MME and complete the connection.

In addition, the base station may configure a packet duplicate transmission technology through the RRCConnectionReconfiguration message. Specifically, a packet duplication technology may be configured for the terminal by the base station through an RRC message by applying a dual connectivity technology or a carrier dual connectivity technology. Specifically, the base station may configure, for the terminal, multiple RLC layer devices connected to one MAC layer device and may configure the multiple RLC layer devices to be connected to one PDCP layer device and to perform packet duplication. As another method, the base station and the terminal may configure multiple RLC layer devices connected to one MCG MAC layer device, also configure multiple RLC layer devices connected to one SCG MAC layer device, configure the multiple RLC layer devices connected to the different MAC layer devices to be connected to one PDCP layer device and to perform packet duplication.

In addition, the base station may indicate, to the terminal, which RLC layer device is a primary RLC layer device or secondary RLC layer devices among multiple RLC layer devices through an RRC message by using a logical channel identifier and a bearer identifier. For example, the base station may indicate each RLC layer device configuration information and indicate a bearer identifier and a logical channel identifier corresponding to each RLC layer device through cell group configuration information.

In addition, the base station may, through bearer configuration information, indicate each PDCP layer device configuration information, indicate a bearer identifier corresponding to each PDCP layer device and, when multiple RLC layer devices are configured for the PDCP layer device or the bearer identifier, indicate a logical channel identifier corresponding to a primary RLC layer device to indicate the primary RLC layer device. Therefore, when an RRC message is received, a terminal may configure a PDCP layer device, based on a bearer identifier, configure multiple RLC layer devices corresponding to the bearer identifier to be connected to the PDCP layer device, and designate a primary RLC layer device and multiple secondary RLC layer devices.

As another method, when the base station configures, for the terminal, multiple RLC layer devices connected to one PDCP layer device through an RRC message, the base station may indicate which RLC layer device is a primary RLC layer or secondary RLC layer devices among multiple RLC layer devices by using a logical channel identifier (or Scell identifier) and a bearer identifier. For example, the base station may indicate each RLC layer device configuration information and indicate a bearer identifier and a logical channel identifier (or Scell identifier) corresponding to each RLC layer device through cell group configuration information.

In addition, the base station may, through bearer configuration information, indicate each PDCP layer device configuration information, indicate a bearer identifier corresponding to each PDCP layer device and, when multiple RLC layer devices are configured for the PDCP layer device or the bearer identifier, indicate a logical channel identifier (or Scell identifier) corresponding to a primary RLC layer device to indicate the primary RLC layer device. Therefore, when the RRC message is received, the terminal may configure a PDCP layer device, based on a bearer identifier, configure multiple RLC layer devices corresponding to the bearer identifier to be connected to the PDCP layer device, and designate a primary RLC layer device and multiple secondary RLC layer devices by using the logical channel identifier or Scell identifier.

In addition, if a new identifier (e.g., logical channel identifier, such as 0, 1, 2, or 3) is configured for each of multiple RLC layer devices connected to one PDCP layer device through an RRC message, the terminal may identify a primary RLC layer device or a secondary RLC layer device, and distinguish between secondary RLC layer devices, based on the new identifier. Alternatively, if packet duplication is configured, the terminal may activate or deactivate RLC layer devices indicated to be activated or deactivated by an RRC message or a MAC CE with respect to RLC layer devices connected to a PDCP layer device for which the packet duplication is configured. The terminal may map bitmap information of an RRC message or MAC control information in ascending order (or descending order) of the new identifier and map respective bits to secondary RLC layer devices to distinguish between the secondary RLC layer devices.

Therefore, the base station may indicate activation or deactivation for each of secondary RLC layer devices by using MAC control information (MAC CE), and when the terminal receives the RRC message or the MAC control information, the terminal may activate or deactivate a secondary RLC layer device corresponding thereto. RLC layer devices indicated to be activated or deactivated by an RRC message or a MAC CE may be allocated only to secondary RLC layer devices, the primary RLC layer device may always maintain an activated state, and the primary RLC layer device may not be deactivated. This is because, if the primary RLC layer device is maintained to be in an activated state, a PDCP layer device has an RLC layer device to which the PDCP layer device is always able to transmit data, and thus the PDCP layer device may always transmit PDCP control data to the primary RLC layer device regardless of an activated or deactivated state of a packet duplication function (e.g., if the packet duplication function is activated or deactivated), so that the complexity of implementation may be minimized.

In addition, the base station may transmit a terminal capability request message (e.g., a UECapabilityEnquiry message) to the terminal, thereby inquiring a capability of the terminal, and when the terminal capability request message is received, the terminal may configure a terminal capability report message (e.g., a UECapabilityInformation message) including a technology, a function, or a capability supported by the terminal, and report the message to the base station. The terminal may report, to the base station, whether the terminal capability (UE capability) supports a maximum of 2 RLC layer devices to be configured in one PDCP layer device or one bearer (e.g., a release 15 terminal or a terminal implemented based on a release 15 specification), or whether the terminal capability (UE capability) supports a maximum of 4 RLC layer devices to be configured in one PDCP layer device or one bearer (e.g., a release 16 or post release 16 terminal or a terminal implemented based on a release 16 specification or a post release 16 specification). When the terminal capability report message is received, the base station may identify the terminal capability, and configure a packet duplication technology or a packet duplication bearer corresponding thereto for the terminal by using an RRC message described above.

If the above processes are all completed, the terminal may transmit or receive data to or from the base station through a core network. According to an embodiment of the disclosure, a data transmission process may include 3 stages including RRC connection establishment, security configuration, and DRB configuration. However, the disclosure is not limited to the example and may include more stages or fewer stages. In addition, the base station may transmit an RRC Connection Reconfiguration message so as to provide a new configuration to the terminal for a predetermined reason, add a configuration, or change a configuration. For example, the base station may perform configuration of adding, releasing, or changing an Scell in a carrier aggregation technology, and change, release, or add an SCG configuration in a dual connectivity technology.

According to an embodiment of the disclosure, a procedure of configuring, by a base station, a carrier aggregation technology or a dual connectivity technology for a terminal may be summarized as follows. First, a terminal may establish a connection with a base station, and if the base station configures frequency measurement configuration information for the terminal in an RRC connected mode, the terminal may perform frequency measurement, based on the frequency measurement configuration information and report a result of the measurement to the base station. Then, the base station may configure configuration information on an additional Scell by using an RRC message so as to configure a carrier aggregation technology for the terminal, based on the frequency measurement result of the terminal, and transmits a MAC CE to activate, dormantize, or deactivate Scells. In addition, the base station may configure additional cell group (e.g., secondary cell group) configuration information so as to configure a dual connectivity technology for the terminal, based on the frequency measurement result of the terminal. In addition, the base station may configure a packet duplicate transmission technology together.

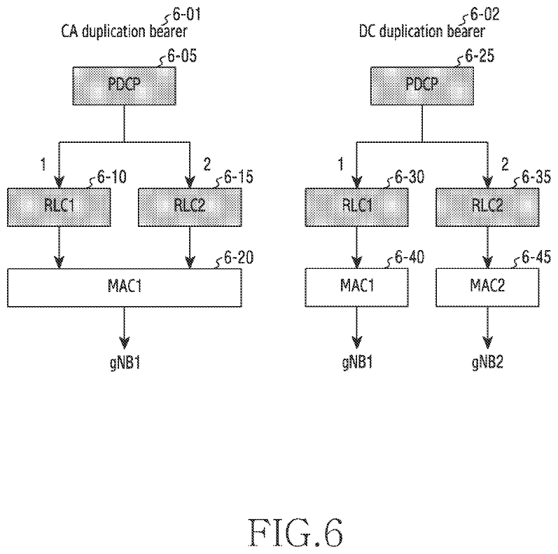

FIG. 6 is a diagram illustrating a first protocol layer device structure for which a packet duplication technology is configured, according to an embodiment of the disclosure.

In FIG. 6, a packet duplication technology may be configured for a terminal by a base station through an RRC message by applying a carrier dual connectivity technology (6-01), and specifically, the base station may configure 2 RLC layer devices 6-10 and 6-15 connected to one MAC layer device 6-20 and configure the 2 RLC layer devices to be connected to one PDCP layer device 6-05 and to perform packet duplication. Reference numeral 6-01 or 6-02 illustrated in FIG. 6 denotes a carrier aggregation technology-based packet duplication bearer 6-01 or a dual connectivity technology-based packet duplication bearer 6-02 which may be configured for a terminal (e.g., a release 15 terminal or a terminal implemented based on a release 15 specification) that supports a maximum of 2 RLC layer devices to be configured in one PDCP layer device or one bearer by a terminal capability (UE capability).

In FIG. 6, a packet duplication technology may also be applied to a dual connectivity technology and be configured for the terminal by the base station through an RRC message, and specifically, the base station may configure multiple RLC layer devices 6-30 and 6-35 connected to different MAC layer devices 6-40 and 6-45, to be connected to one PDCP layer device 6-25 and to perform packet duplication. In addition, a packet duplication technology may be configured in each of multiple bearers or multiple PDCP layer devices of one terminal.

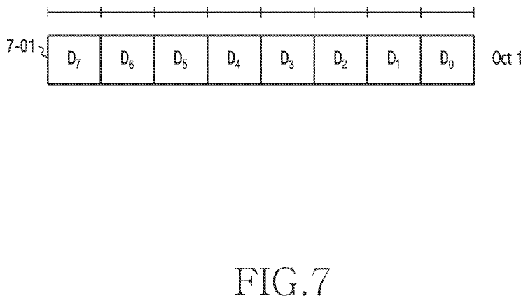

FIG. 7 illustrates first MAC control information (MAC control element) proposed in the disclosure to indicate packet duplication activation or deactivation to a terminal for which a packet duplication technology or a packet duplication bearer is configured as proposed in FIG. 6. The first MAC control information may also be called first type MAC control information. A terminal may indicate a terminal (e.g., a release 15 terminal or a terminal implemented based on a release 15 specification) that supports a maximum of 2 RLC layer devices to be configured in one PDCP layer device or one bearer by a terminal capability (UE capability).

In FIG. 7, a base station may configure MAC control information 7-01, attach a MAC subheader to the front side of same, and transmit the MAC control information and the MAC subheader to a terminal for which a packet duplicate transmission technology is configured, so as to instruct the terminal to activate or deactivate a packet duplication function (or perform duplicate transmission or stop duplicate transmission) for each packet duplication bearer (e.g., a bearer in which a packet duplication function is configured or a bearer in which 2 RLC layer devices (or logical channel identifiers) are configured in one PDCP layer device) of multiple packet duplication bearers configured for the terminal. A MAC subheader for MAC control information may not have an L field to achieve fast processing of the MAC control information in the terminal, and the MAC subheader and the MAC control information may have a fixed size

First MAC control information (e.g., duplication activation/deactivation MAC CE) has a size of 1 byte, and may be distinguished by a logical channel identifier of a MAC subheader. The 1 byte size of the first MAC control information may include bitmap information configured by D(i) fields as the MAC control information 7-01. The length of the logical channel identifier may have a size of 6 bits.
D(i) field: The D(i) field may indicate an activated state or a deactivated state of a packet duplication function for DRB(i) (or i-th DRB). Here, (i) may be determined in ascending order of a DRB identifier (or bearer identifier) with respect to DRBs in which RLC layer devices connected to the MAC layer device are configured and a packet duplication function is configured (or (i) may be mapped to the DRBs). If a D(i) field is configured to be 1. this may indicate that a packet duplication function of DRB(i) is required to be activated. In addition, if a D(i) field is configured to be 0, this may indicate that a packet duplication function of DRB(i) is required to be deactivated.

In order to indicate, through first MAC control information, activation or deactivation of a packet duplication function for each bearer (or DRB) in which the packet duplication function is configured, a D(i) field having a size of I bit for each bearer is required to be defined and used to efficiently configure the MAC control information. The reason why 1 bit is enough is that, in relation to a packet duplication bearer controlled by first MAC control information, a maximum of 2 RLC layer devices may be configured (i.e., one primary RLC layer device or one secondary RLC layer device may be configured) for a packet duplication bearer (e.g., a bearer having a first protocol layer device structure) as proposed in FIG. 6, the primary RLC layer device is unable to be deactivated and is always active, and thus eventually it is enough to indicate activation or deactivation of only one secondary RLC layer device.

That is, first MAC control information proposed above has a very efficient structure when being used by a terminal (e.g., a release 15 terminal or a terminal implemented based on a release 15 specification) that supports a maximum of 2 RLC layer devices to be configured in one PDCP layer device or one bearer by a terminal capability (UE capability).

FIG. 8 is a diagram illustrating a second protocol layer device structure for which a packet duplication technology is configured, according to an embodiment of the disclosure.

In FIG. 8, a packet duplication technology may be configured for a terminal by a base station through an RRC message by applying a carrier dual connectivity technology (8-01), and specifically, the base station may configure a maximum of 4 RLC layer devices 8-05, 8-10, 8-15, and 8-20 connected to one MAC layer device and configure the respective RLC layer devices to be connected to one PDCP layer device and to perform packet duplication. Reference numeral 8-01 or 8-02 illustrated in FIG. 8 denotes a carrier aggregation technology-based packet duplication bearer 8-01 or a carrier aggregation technology or dual connectivity technology-based packet duplication bearer 8-02 which may be configured for a terminal (e.g., a release 16 or post release 16 terminal or a terminal implemented based on a release 16 or post release 16 specification) that supports a maximum of 4 RLC layer devices to be configured in one PDCP layer device or one bearer by a terminal capability (UE capability).

The disclosure proposes a method of, in a case where multiple RLC layer devices (or logical channel identifiers) are configured for a terminal for which a packet duplicate transmission technology is configured as illustrated in FIG. 8, dynamically indicating activation of some RLC layer devices among the configured multiple RLC layer devices (i.e., to perform duplicate transmission) (the devices 8-05, 8-20, 8-25, and 8-35) or deactivation of same (i.e., to stop duplicate transmission) (devices 8-10, 8-15, 8-30, and 8-40). In the method proposed in the disclosure, a primary RLC layer device may not be deactivated, be unable to be deactivated, or not be subject to deactivation. In addition, a packet duplication technology may be configured in each of multiple bearers or multiple PDCP layer devices of one terminal.

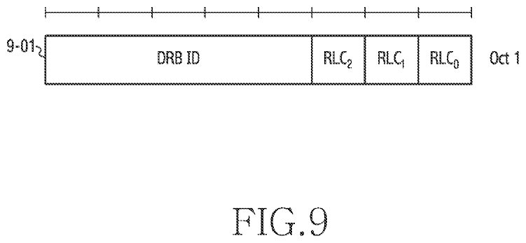

FIG. 9 illustrates second MAC control information proposed in the disclosure to indicate packet duplication activation or deactivation to a terminal for which a packet duplication technology or a packet duplication bearer is configured as proposed in FIG. 8. The second MAC control information may also be called second type MAC control information. A terminal may indicate a terminal (e.g., a release 16 or post release 16 terminal or a terminal implemented based on a release 16 or post release 16 specification) that supports a maximum of 4 RLC layer devices to be configured in one PDCP layer device or one bearer by a terminal capability (UE capability).

In FIG. 9, a base station may configure MAC control information 9-01, attach a MAC subheader to the front side of same, and transmit the MAC control information and the MAC subheader to a terminal for which a packet duplicate transmission technology is configured, so as to instruct the terminal to activate or deactivate a packet duplication function (or perform duplicate transmission or stop duplicate transmission) for one packet duplication bearer (e.g., a bearer in which a packet duplication function is configured or a bearer in which a maximum of 4 RLC layer devices (or logical channel identifiers) are configured in one PDCP layer device) among multiple packet duplication bearers configured for the terminal. A MAC subheader for MAC control information may not have an L field to achieve fast processing of the MAC control information in the terminal, and the MAC subheader and the MAC control information may have a fixed size.

Second MAC control information (e.g., duplication RLC activation/deactivation MAC CE) has a size of 1 byte, and may be distinguished by an extended logical channel identifier (extended LCID, eLCID) of a MAC subheader. The 1 byte size of the second MAC control information may include information configured by a bearer identifier field (or DRB ID field) and RLC(i) fields as indicated by reference numeral 9-01. The length of the extended logical channel identifier may be configured by a size of 8 bits or 16 bits to indicate many types of data and MAC control information.
DRB ID field (DRB identifier or bearer identifier field): A DRB ID field may indicate an identifier of a DRB to which second MAC control information needs to be applied. The length of the DRB ID field may have a size of 5 bits. An identifier of a DRB is a bearer identifier and may be configured by an RRC message of the disclosure.
RLC(i) field: The RLC(i) field may indicate an activated state or a deactivated state of a packet duplication function for RLC layer device(i) (or i-th RLC layer device or secondary RLC layer device). Here, (i) may be determined in ascending order of logical channel identifiers of secondary RLC layer devices for (or configured for) the DRB (e.g., a DRB indicated by a DRB ID field) in a sequence of an MCG and an SCG (or (i) may be mapped to the secondary RLC layer devices). For example, when an RLC(i) field in the MAC control information 9-01 is mapped to logical channel identifiers of secondary RLC layer devices, secondary RLC layer devices for an MCG may be mapped in ascending order (or descending order) of the identifier value from the least significant bit (LSB) or from the right, and then secondary RLC layer devices for an SCG may be mapped in ascending order (or descending order) of the identifier value from the least significant bit (LSB) or from the right. If an RLC(i) field is configured to be 1, this may indicate that a packet duplication function of RLC layer device (i) is required to be activated. In addition, if an RLC(i) field is configured to be 0, this may indicate that a packet duplication function of RLC layer device (i) is required to be deactivated.

In order for second MAC control information to indicate activation or deactivation of a packet duplication function of each secondary RLC layer device configured in a bearer (or DRB) in which the packet duplication function is configured, a bearer identifier (or DRB ID field) for the bearer and RLC(i) fields having a size of 3 bits are required to be defined and used to efficiently configure the MAC control information. The reason why 3 bits are enough is that, in relation to a packet duplication bearer controlled by second MAC control information, a maximum of 4 RLC layer devices may be configured (i.e., one primary RLC layer device or a maximum of 3 secondary RLC layer devices may be configured) for a packet duplication bearer (e.g., a bearer having a second protocol layer device structure) as proposed in FIG. 8, the primary RLC layer device is unable to be deactivated and is always active, and thus eventually it is enough to indicate activation or deactivation of only 3 secondary RLC layer devices. That is, second MAC control information has a very efficient structure when being used by a terminal (e.g., a release 16 or post release 16 terminal or a terminal implemented based on a release 16 or post release 16 specification) that supports a maximum of 4 RLC layer devices to be configured in one PDCP layer device or one bearer by a terminal capability (UE capability).

The number of RLC layer devices described above may indicate the number of RLC layer devices in the uplink direction (or RLC layer devices in the downlink direction). This is because a packet duplication technology or an indication of activation and deactivation of the packet duplication technology is related to uplink data transmission of a terminal. For example, the number of layer devices of a packet duplication bearer configured to have the first protocol layer device structure proposed in FIG. 6 may be as follows according to the type of an RLC layer device (an AM RLC layer device operating in an AM mode or a UM RLC layer device operating in an UM mode).
A first packet duplication bearer configured to have the first protocol layer device structure may be configured by 2 AM RLC layer devices (AM RLC layer devices supporting both directions (uplink and downlink)).
A second packet duplication bearer configured to have the first protocol layer device structure may be configured by 2 UM RLC layer devices of the uplink direction.
A third packet duplication bearer configured to have the first protocol layer device structure may be configured by 2 UM RLC layer devices of the downlink direction.
A fourth packet duplication bearer configured to have the first protocol layer device structure may be configured by 4 RLC layer devices including 2 UM RLC layer devices of the uplink direction and 2 UM RLC layer devices of the downlink direction.

The number of layer devices of a packet duplication bearer configured to have the second protocol layer device structure proposed in FIG. 8 may be as follows according to the type of an RLC layer device (an AM RLC layer device operating in an AM mode or a UM RLC layer device operating in an UM mode).
In a fifth packet duplication bearer configured to have the second protocol layer device structure, N UM RLC layer devices may be configured for the same direction (uplink or downlink), 2×N UM RLC layer devices may be configured (2×N UM RLC layer devices may be configured by configuring N UM RLC layer devices for the same direction and summing N UM RLC layer devices in the uplink direction and N UM RLC layer devices in the downlink direction), or N AM RLC layer devices may be configured, and the value of N may be greater than 2 or be equal to or smaller than 4 (2<N<=4).
If N UM RLC layer devices are configured for the same direction (uplink or downlink) in a DRB (or at least one DRB configured for the terminal), 2×N UM

RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and if the value of N is greater than 2 or be equal to or smaller than 4 (2<N<=4), the terminal and the base station may not use the first MAC control information (duplication activation/deactivation MAC CE) proposed in FIG. 7.

Hereinafter, a problem which may occur due to use of the first MAC control information proposed in FIG. 7 or the second MAC control information proposed in FIG. 9 is described and a solution thereof is proposed.

A base station may configure a packet duplication bearer having a second protocol layer device structure as illustrated with reference to FIG. 8, for a terminal (e.g., a release 16 or post release 16 terminal or a terminal implemented based on a release 16 or post release 16 specification) that supports a maximum of 4 RLC layer devices to be configured in one PDCP layer device or one bearer by a terminal capability (UE capability).

However, if the base station configures and transmits, to the terminal, the first MAC control information proposed in FIG. 7 to indicate activation or deactivation of a packet duplication function, activation or deactivation of a maximum of 4 secondary RLC layer devices is unable to be normally indicated to the terminal. This is because the first MAC control information includes only information of 1 bit for each packet duplication bearer and thus is unable to indicate each state (activated or deactivated state) of a maximum of 3 secondary RLC layer devices, so that error or false operation may occur in terminal implementation.

Therefore, in order to prevent error or false operation which may occur in the terminal, the following description proposes methods enabling the first MAC control information proposed in FIG. 7 to be used only for a packet duplication bearer configured to have the first protocol layer device structure proposed in FIG. 6. That is, the following description proposes methods of restricting the first MAC control information proposed in FIG. 7 from being used for a packet duplication bearer configured to have the second protocol layer device structure proposed in FIG. 8.
First method:—If N UM RLC layer devices are configured for the same direction (uplink or downlink) in a DRB (or at least one DRB configured for the terminal), 2×N UM RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and the value of N is greater than 2 or be equal to or smaller than 4 (2<N<=4), at least one of the terminal and the base station may determine or decide not to use the first MAC control information (duplication activation/deactivation MAC CE) proposed in FIG. 7 (e.g., the base station may determine or decide not to use (or not to transmit) the first MAC control information proposed in FIG. 7 and determine or decide to use (or to transmit) the second MAC control information proposed in FIG. 9). For example, if a packet duplication bearer configured to have the second protocol layer device structure proposed in FIG. 8 is configured for the terminal (or at least one packet duplication bearer is configured), the base station may not use the first MAC control information (e.g., the duplication activation/deactivation MAC CE is not used if a DRB is configured with N UM RLC entities (for same direction), 2*N UM RLC entities (N for each direction), or N AM RLC entities, where 2<N<=4.).

As another method, only if N UM RLC layer devices are configured for the same direction (uplink or downlink) in a DRB (or packet duplication bearers (DRBs) configured for the terminal), 2×N UM RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and the value of N is equal to 2 (N=2), at least one of the terminal and the base station may determine or decide to use the first MAC control information (duplication activation/deactivation MAC CE) proposed in FIG. 7 (e.g., the base station may determine or decide to use (or to transmit) the first MAC control information proposed in FIG. 7 and determine or decide not to use (or not to transmit) the second MAC control information proposed in FIG. 9). For example, only if all packet duplication bearers configured for the terminal are configured to have one structure of the first protocol layer device structure proposed in FIG. 6, it is possible to use the first MAC control information proposed in FIG. 7 (e.g., the duplication activation/deactivation MAC CE is used only if all the configured DRBs have a first structure where the first structure implies a DRB configured with N UM RLC entities (for same direction), 2*N UM RLC entities (N for each direction), or N AM RLC entities, where N=2.)

As another method, only if N UM RLC layer devices are not configured for the same direction (uplink or downlink) in each of all configured DRBs (or all packet duplication bearers (DRBs) configured for the terminal), 2×N UM RLC layer devices are not configured (2×N UM RLC layer devices may be configured by configuring N UM RLC layer devices for the same direction and summing N UM RLC layer devices in the uplink direction and N UM RLC layer devices in the downlink direction), N AM RLC layer devices are not configured, and the value of N is greater than 2 or equal to and smaller than 4 (2<N<=4), at least one of the terminal and the base station may determine or decide to use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if none of packet duplication bearers configured for the terminal are configured to have the second protocol layer device structure proposed in FIG. 8, it is possible to use the first MAC control information proposed in FIG. 7 (e.g., if all the configured DRBs are not configured with N UM RLC entities (for same direction) and if all the configured DRBs are not configured with 2*N UM RLC entities (N for each direction) and if all the configured DRBs are not configured with N AM RLC entities, where 2<N<=4, the Duplication Activation/Deactivation MAC CE is used.).
Second method:—If more than N UM RLC layer devices are configured for the same direction (uplink or downlink) in a DRB (or at least one DRB configured for the terminal), more than 2×N UM RLC layer devices are configured (more than 2×N UM RLC layer devices may be configured by configuring more than N UM RLC layer devices for the same direction and summing more than N UM RLC layer devices in the uplink direction and more than N UM RLC layer devices in the downlink direction), or more than N AM RLC layer devices are configured, and if the value of N is equal to or greater than 2 or be equal to or smaller than 4 (2<=N<=4), at least one of the terminal and the base station may determine or decide not to use the first MAC control information (duplication activation/deactivation MAC CE) proposed in FIG. 7 (e.g., in this case, the base station may determine or decide not to use (or not to transmit) the first MAC control information proposed in FIG. 7 and determine or decide to use (or to transmit) the second MAC control information proposed in FIG. 9). For example, if a packet duplication bearer configured to have the second protocol layer device structure proposed in FIG. 8 is configured for the terminal (or at least one packet duplication bearer is configured), the base station may not use the first MAC control information (e.g., the duplication activation/deactivation MAC CE is not used if a DRB is configured with more than N UM RLC entities (for same direction), 2*N UM RLC entities (N for each direction), or N AM RLC entities, where 2<N<=4.).

As another method, if N UM RLC layer devices are configured for the same direction (uplink or downlink) in a DRB (or packet duplication bearers (DRBs) configured for the terminal), 2×N UM RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and only if the value of N is equal to 2 (N=2), at least one of the terminal and the base station may determine or decide to use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if all packet duplication bearers configured for the terminal are configured to have one structure of the first protocol layer device structure proposed in FIG. 6, the terminal and the base station may use the first MAC control information proposed in FIG. 7 (e.g., the duplication activation/deactivation MAC CE is used only if all the configured DRBs have a first structure where the first structure implies a DRB configured with N UM RLC entities (for same direction), 2*N UM RLC entities (N for each direction), or N AM RLC entities, where N=2.)

As another method, only if more than N UM RLC layer devices are not configured for the same direction (uplink or downlink) in each of all configured DRBs (or all packet duplication bearers (DRBs) configured for the terminal), more than 2×N UM RLC layer devices are not configured (more than 2×N UM RLC layer devices may be configured by configuring more than N UM RLC layer devices for the same direction and summing more than N UM RLC layer devices in the uplink direction and more than N UM RLC layer devices in the downlink direction), more than N AM RLC layer devices are not configured, and the value of N is equal to or greater than 2 or equal to and smaller than 4 (2<=N<=4), at least one of the terminal and the base station may determine or decide to use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if none of packet duplication bearers configured for the terminal are configured to have the second protocol layer device structure proposed in FIG. 8, it is possible to use the first MAC control information proposed in FIG. 7 (e.g., if all the configured DRBs are not configured with more than N UM RLC entities (for same direction) and if all the configured DRBs are not configured with more than 2*N UM RLC entities (N for each direction) and if all the configured DRBs are not configured with more than N AM RLC entities, where 2<=N<=4. the Duplication Activation/Deactivation MAC CE is used)
Third method: If more than two UM RLC layer devices or more than two AM RLC layer devices are configured for the uplink direction in a DRB (or at least one DRB configured for the terminal), at least one of the terminal and the base station may determine or decide not to use the first MAC control information (duplication activation/deactivation MAC CE) proposed in FIG. 7 (e.g., in this case, the base station may determine or decide not to use (or not to transmit) the first MAC control information proposed in FIG. 7 and determine or decide to use (or to transmit) the second MAC control information proposed in FIG. 9). For example, if a packet duplication bearer configured to have the second protocol layer device structure proposed in FIG. 8 is configured for the terminal (or at least one packet duplication bearer is configured), the base station may not use the first MAC control information (e.g., the duplication activation/deactivation MAC CE is not used if a DRB is configured with more than two AM RLC entities or more than two UM RLC entities for uplink direction.).

As another method, if N UM RLC layer devices are configured for the same direction (uplink or downlink) in a DRB (or packet duplication bearers (DRBs) configured for the terminal), 2×N UM RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and only if the value of N is equal to 2 (N=2), at least one of the terminal and the base station may allow use of the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if all packet duplication bearers configured for the terminal are configured to have one structure of the first protocol layer device structure proposed in FIG. 6, the first MAC control information proposed in FIG. 7 may be used (e.g., the duplication activation/deactivation MAC CE is used only if all the configured DRBs have a first structure where the first structure implies a DRB configured with N UM RLC entities (for same direction), 2*N UM RLC entities (N for each direction), or N AM RLC entities, where N=2.)

As another method, if more than two UM RLC layer devices are not configured for the uplink direction in each of all configured DRBs (or all packet duplication bearers (DRBs) configured for the terminal) and more than two AM RLC layer devices are not configured, at least one of the terminal and the base station may determine or decide to use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if none of packet duplication bearers configured for the terminal are configured to have the second protocol layer device structure proposed in FIG. 8, the first MAC control information proposed in FIG. 7 may be used (e.g., if all the configured DRBs are not configured with more than 2 UM RLC entities (for uplink direction) and if all the configured DRBs are not configured with more than 2 AM RLC entities, the Duplication Activation/Deactivation MAC CE is used).
Fourth method: If more than two RLC layer devices are configured for the uplink direction in a DRB (or at least one DRB configured for the terminal), at least one of the terminal and the base station may determine or decide not to use the first MAC control information (duplication activation/deactivation MAC CE) proposed in FIG. 7 (e.g., in this case, the base station may determine or decide not to use (or not to transmit) the first MAC control information proposed in FIG. 7 and determine or decide to use (or to transmit) the second MAC control information proposed in FIG. 9). For example, if a packet duplication bearer configured to have the second protocol layer device structure proposed in FIG. 8 is configured for the terminal (or at least one packet duplication bearer is configured), the base station may not use the first MAC control information (e.g., the duplication activation/deactivation MAC CE is not used if a DRB is configured with more than two RLC entities).

As another method, if N UM RLC layer devices are configured for the same direction (uplink or downlink) in a DRB (or packet duplication bearers (DRBs) configured for the terminal), 2×N UM RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and only if the value of N is equal to 2 (N=2), the terminal and the base station may determine or decide to use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if all packet duplication bearers configured for the terminal are configured to have one structure of the first protocol layer device structure proposed in FIG. 6, the first MAC control information proposed in FIG. 7 may be used (e.g., the duplication activation/deactivation MAC CE is used only if all the configured DRBs have a first structure where the first structure implies a DRB configured with N UM RLC entities (for same direction), 2*N UM RLC entities (N for each direction), or N AM RLC entities, where N=2).

As another method, if more than two RLC layer devices are not configured in each of all configured DRBs (or all packet duplication bearers (DRBs) configured for the terminal), at least one of the terminal and the base station may determine or decide to use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if none of packet duplication bearers configured for the terminal are configured to have the second protocol layer device structure proposed in FIG. 8, the first MAC control information proposed in FIG. 7 may be used (e.g., if all the configured DRBs are not configured with more than 2 RLC entities, the duplication activation/deactivation MAC CE is used).

In addition, when activation and deactivation of multiple secondary RLC layer devices are indicated by a MAC CE or MAC header proposed in the disclosure, if all secondary RLC layer devices configured for a bearer to which a packet duplication technology is applied are deactivated, the terminal may stop packet duplicate transmission and operate like a normal bearer.

In addition, a case will be described, and the case is that, when activation and deactivation of multiple secondary RLC layer devices are indicated by a MAC CE or MAC header proposed in the disclosure, multiple secondary RLC layer devices configured for a bearer to which a packet duplication technology is applied are deactivated, only one secondary RLC layer device is active (e.g., 2 secondary RLC layer devices are deactivated among 3 activated or configured secondary RLC layer devices, one secondary RLC layer device is deactivated among 2 activated or configured secondary RLC layer devices, or one activated or configured secondary RLC layer device is active), and an indication to deactivate the one secondary RLC layer device is received (i.e., the MAC CE indicates to deactivate all secondary RLC layer devices configured by an RRC message, or the MAC CE indicates to deactivate all secondary RLC layer devices configured by an RRC message so that packet duplication for the bearer is deactivated). If a structure of a primary RLC layer device of the bearer for which packet duplicate transmission is configured and a secondary RLC layer device (or a secondary RLC layer device configured in advance for the use of a split bearer by an RRC message) lastly indicated to be deactivated (or having the smallest or greatest logical channel identifier value) is the same as a split bearer of a dual connectivity technology (i.e., the primary RLC layer device and the secondary RLC layer device are connected to different MAC layer devices (MCG MAC or SCG MAC), or the secondary RLC layer device is connected to a MAC layer device (e.g., SCG MAC) different from a MAC layer device to which the primary RLC layer device is connected), the terminal may stop packet duplication for the bearer performing packet duplicate transmission and fallback to operate like a split bearer of the dual connectivity technology, which distributes and transmits different pieces of data to different RLC layer devices (the primary RLC layer device and the secondary RLC layer device) so as to improve a data rate.

As another method, an indicator may be defined, configured, and indicated in an RRC message or MAC CE, thereby, in the above case, indicating that a secondary RLC layer device to be used as a split bearer is configured in advance and is applied to the packet duplication technology described above. Alternatively, an indicator may be used to always apply the packet duplication technology. Alternatively, the packet duplication technology may be allowed to be always applied even without an indicator.

Even when an indication to deactivate a secondary RLC layer device is received by the terminal, if the secondary RLC layer device operates in an AM mode, the terminal may continuously perform retransmission of a piece of data, among pieces of transmitted data, for which an ACK (RLC ACK) for successful transfer has failed to be received, and continuously transmit an RLC PDU that has not been transmitted yet but configured.

In addition, even when an indication to deactivate a secondary RLC layer device is received by the terminal, if the secondary RLC layer device operates in a UM mode, the terminal may continuously transmit an RLC PDU that has not been transmitted yet but configured. In addition, even when an indication to deactivate a secondary RLC layer device is received by the terminal, the terminal may continuously receive downlink data from the base station through the secondary RLC layer device. In addition, when a secondary RLC layer device having been deactivated is activated, the terminal may not initialize an existing RLC sequence number, and assign an RLC sequence number having not been transmitted vet to configure data to be transmitted.

In addition, when the base station configures a packet duplication technology for each bearer for the terminal as illustrated in FIG. 5, in order to reduce a delay of activation of secondary RLC layer devices connected to a bearer for which the packet duplication function is configured, the base station may indicate whether to activate each secondary RLC layer device when configuring multiple secondary RLC layer devices connected to the bearer by using an RRC message. That is, the base station may directly indicate activation or deactivation of each secondary RLC layer device by defining an indicator when configuring the secondary RLC layer device by using an RRC message. Alternatively, the terminal may be configured to determine to activate configured secondary RLC layer devices.

The base station may configure which cell or which frequency for which duplicate date processed and configured in each RLC layer device is to be transmitted, when configuring multiple RLC layer devices for each bearer (or PDCP layer device) for which a packet duplication technology is configured, and may configure respective pieces of duplicate data to be transmitted to different cells and thus have multiplexing gain Therefore, in the disclosure, the base station may configure mapping information for the terminal to transmit, to corresponding particular cells, data generated in multiple RLC layer devices connected to a PDCP layer device for which a packet duplication technology is configured by an RRC message, or data corresponding to logical channel identifiers of the RLC layer devices.

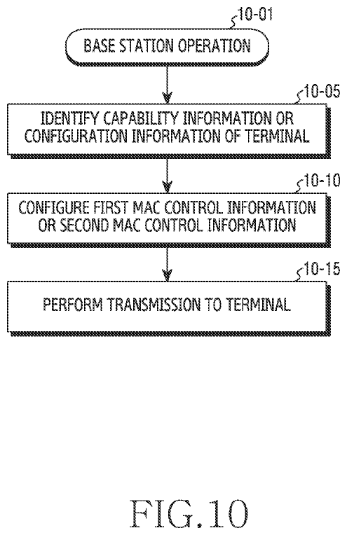

FIG. 10 is a diagram illustrating a base station operation 10-01 proposed in the disclosure.

In the disclosure, a base station may transmit, to a terminal, a terminal capability request message that requests capability information of the terminal from the terminal, receive a terminal capability report message in response to the message, and identify or recognize a capability of the terminal. The base station may configure, for the terminal, a packet duplication function for each bearer through an RRC message according to the terminal capability.

The base station may obtain or identify the capability information of the terminal or configuration information (e.g., packet duplication bearer configuration information) configured for the terminal (operation 10-05). Thereafter, the base station may configure and transmit (or use) first MAC control information that activates or deactivates the packet duplication function of a packet duplication bearer of the terminal or each RLC layer device or configure and transmit (or use) second MAC control information, based on the capability information of the terminal or the configuration information configured for the terminal (operations 10-10 and 10-15).

Specifically, if N UM RLC layer devices are configured for the same direction (uplink or downlink) in a DRB configured for the terminal (or at least one DRB configured for the terminal), 2×N UM RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and if the value of N is greater than 2 or be equal to or smaller than 4 (2<N<=4), the base station may not use the first MAC control information (i.e., duplication activation/deactivation MAC CE) proposed in FIG. 7. For example, in the above case, the base station may determine or decide not to use (or not to transmit) the first MAC control information proposed in FIG. 7 and determine or decide to use (or to transmit) the second MAC control information proposed in FIG. 9. For example, if a packet duplication bearer configured to have the second protocol layer device structure proposed in FIG. 8 is configured for the terminal (or at least one packet duplication bearer is configured), the base station may not use the first MAC control information.

As another method, if N UM RLC layer devices are configured for the same direction (uplink or downlink) in a DRB configured for the terminal (or packet duplication bearers (DRBs) configured for the terminal), 2×N UM RLC layer devices are configured (2×N UM RLC layer devices may be configured by configuring N UM RLC layer devices for the same direction and summing N UM RLC layer devices in the uplink direction and N UM RLC layer devices in the downlink direction), or N AM RLC layer devices are configured, and only if the value of N is equal to 2 (N=2), the base station may use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if all packet duplication bearers configured for the terminal are configured to have one structure of the first protocol layer device structure proposed in FIG. 6, the first MAC control information proposed in FIG. 7 may be used.

As another method, only if N UM RLC layer devices are not configured for the same direction (uplink or downlink) in each of all configured DRBs (or all packet duplication bearers (DRBs) configured for the terminal), 2×N UM RLC layer devices are not configured (2×N UM RLC layer devices may be configured by configuring N UM RLC layer devices for the same direction and summing N UM RLC layer devices in the uplink direction and N UM RLC layer devices in the downlink direction), N AM RLC layer devices are not configured, and the value of N is greater than 2 or equal to and smaller than 4 (2<N <=4), the base station may use the first MAC control information (duplication activation/deactivation MAC CE) proposed in FIG. 7 (e.g., in this case, the base station may determine or decide to use (or to transmit) the first MAC control information proposed in FIG. 7 and determine or decide not to use (or not to transmit) the second MAC control information proposed in FIG. 9). For example, only if none of packet duplication bearers configured for the terminal are configured to have the second protocol layer device structure proposed in FIG. 8, the first MAC control information proposed in FIG. 7 may be used.

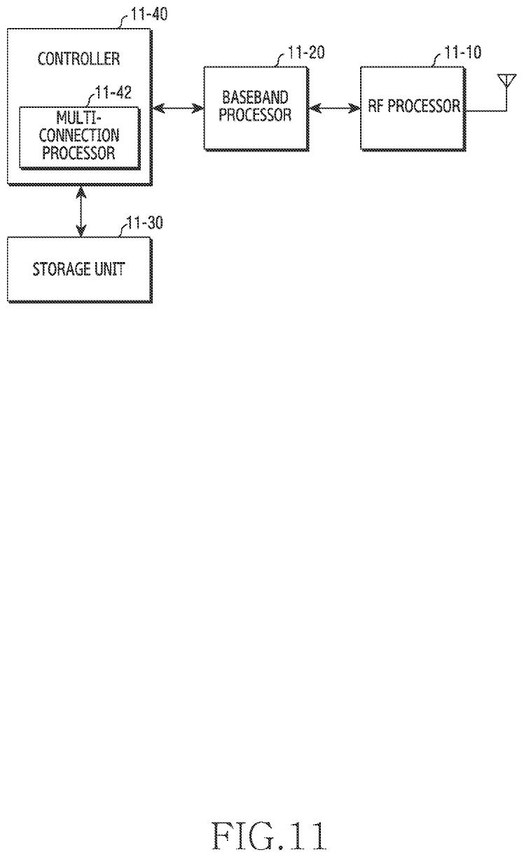

FIG. 11 illustrates a structure of a terminal according to an embodiment of the disclosure.

Referring to the diagram, the terminal may include a radio frequency (RF) processor 11-10, a baseband processor 11-20, a storage unit 11-30, and a controller 11-40. However, the disclosure is not limited to the example, and the terminal may include more or fewer elements, compared to the elements illustrated in FIG. 11.

The RF processor 11-10 may perform a function, such as signal band change, amplification, etc., for transmitting or receiving a signal through a wireless channel. That is, the RF processor 11-10 may upconvert a baseband signal provided from the baseband processor 11-20, into an RF band signal, and then transmit the RF band signal through an antenna, and downconvert an RF band signal received through the antenna, into a baseband signal. For example, the RF processor 11-10 may include a transmission filter, a reception filter, an amplifier, a mixer, an oscillator, a digital-to-analog converter (DAC), an analog-to-digital converter (ADC), and the like. In FIG. 11, only one antenna is illustrated, but the terminal may include a plurality of antennas. Furthermore, the RF processor 11-10 may include a plurality of RF chains. Furthermore, the RF processor 11-10 may perform beamforming. To perform beamforming, the RF processor 11-10 may adjust the phase and size of each of signals transmitted or received through a plurality of antennas or antenna elements. In addition, the RF processor may perform multi-input multi-output (MIMO), and may receive several layers at the time of performing an MIMO operation. The RF processor 11-10 may properly configure multiple antennas or antenna elements according to a control of the controller to perform reception beam sweeping or adjust the direction and the beam width of a reception beam so that the reception beam cooperates with a transmission beam.

The baseband processor 11-20 performs a function of conversion between a baseband signal and a bitstream according to a physical layer specification of a system. For example, at the time of data transmission, the baseband processor 11-20 may generate complex symbols by encoding and modulating a transmission bitstream. In addition, at the time of data reception, the baseband processor 11-20 reconstructs a reception bit stream by demodulating and decoding a baseband signal provided from the RF processor 11-10. For example, in a case where an orthogonal frequency division multiplexing (OFDM) scheme is applied, at the time of data transmission, the baseband processor 11-20 may generate complex symbols by encoding and modulating a transmission bitstream, map the complex symbols to subcarriers, and then configure OFDM symbols through an inverse fast Fourier transform (IFFT) operation and cyclic prefix (CP) insertion. In addition, at the time of data reception, the baseband processor 11-20 may divide a baseband signal provided from the RF processor 11-10, by the units of OFDM symbols, reconstruct signals mapped to subcarriers, through a fast Fourier transform (FFT) operation, and then reconstruct a reception bit stream through demodulation and decoding.

The baseband processor 11-20 and the RF processor 11-10 may transmit and receive a signal as described above. Accordingly, the baseband processor 11-20 and the RF processor 11-10 may be called a transmitter, a receiver, a transceiver, or a communication unit. Furthermore, at least one of the baseband processor 11-20 and the RF processor 11-10 may include a plurality of communication modules to support a plurality of different wireless access technologies. In addition, at least one of the baseband processor 11-20 and the RF processor 11-10 may include different communication modules to process signals in different frequency bands. For example, different wireless access technologies may include LTE network, NR network, etc. In addition, the different frequency bands may include a super high frequency (SHF) (e.g., 2.5 GHZ and 5 GHz) band, and a millimeter (mm) wave (e.g., 60 GHz) band. The terminal may exchange a signal with a base station by using the baseband processor 11-20 and the RF processor 11-10, and the signal may include control information and data.

The storage unit 11-30 stores data such as a basic program, an application program, and configuration information for an operation of the terminal. The storage unit 11-30 may provide stored data according to a request of the controller 11-40. The storage unit 11-30 may provide stored data according to a request of the controller 11-40. The storage unit 11-30 may be configured by a storage medium such as a ROM, a RAM, a hard disk, a CD-ROM, and a DVD, or a combination of storage mediums. In addition, the storage unit 11-30 may be configured by a plurality of memories. According to an embodiment, the storage unit 11-30 may store a program for performing a method for effectively processing MAC control information described above.

The controller 11-40 may control overall operations of the terminal. For example, the controller 11-40 may transmit or receive a signal via the baseband processor 11-20 and the RF processor 11-10. In addition, the controller 11-40 may record and read data in and from the storage unit 11-40. To this end, the controller 11-40 may include at least one processor. For example, the controller 11-40 may include a communication processor (CP) performing control for communication, and an application processor (AP) controlling a higher layer, such as an application program. In addition, at least one element in the terminal may be implemented as a single chip. In addition, according to an embodiment of the disclosure, the controller 11-40 may include a multi-connection processor 11-42 that performs processing for operation in a multi-connection mode.

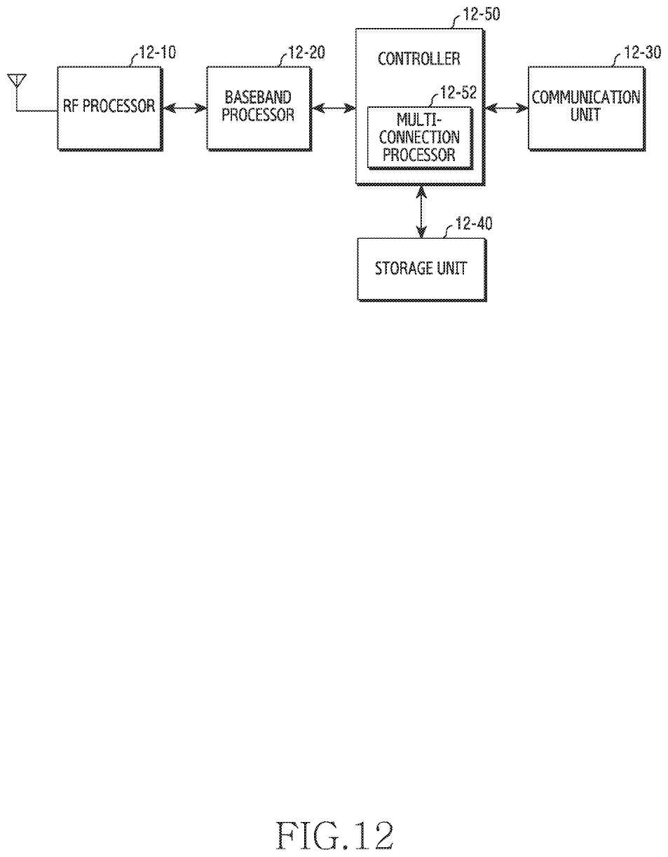

FIG. 12 illustrates a configuration of a transmission and reception point (TRP) in a wireless communication system according to an embodiment of the disclosure.

According to an embodiment of the disclosure, the TRP may include a base station. As illustrated in the diagram, the base station may include an RF processor 12-10, a baseband processor 12-20, a backhaul communication unit 12-30, a storage unit 12-40, and a controller 12-50. However, the disclosure is not limited to the example, and the base station may include more or fewer elements, compared to the elements illustrated in FIG. 12.

The RF processor 12-10 may perform a function, such as signal band change, amplification, etc., for transmitting or receiving a signal through a wireless channel.

That is, the RF processor 12-10 may upconvert a baseband signal provided from the baseband processor 12-20, into an RF band signal, and then transmit the RF band signal through an antenna, and downconvert an RF band signal received through the antenna, into a baseband signal. For example, the RF processor 12-10 may include a transmission filter, a reception filter, an amplifier, a mixer, an oscillator, a DAC, an ADC, and the like. In FIG. 12, only one antenna is illustrated, but the first access node may include a plurality of antennas. Furthermore, the RF processor 12-10 may include a plurality of RF chains. Furthermore, the RF processor 12-10 may perform beamforming. To perform the beamforming, the RF processor 12-10 may adjust the phase and size of each of signals transmitted or received via multiple antennas or antenna elements. The RF processor may perform a downlink MIMO operation by transmitting at least one layer. The RF processor 12-10 may properly configure multiple antennas or antenna elements according to a control of the controller to perform reception beam sweeping or adjust the direction and the beam width of a reception beam so that the reception beam cooperates with a transmission beam.

The baseband processor 12-20 performs a function of conversion between a baseband signal and a bitstream according to a physical layer specification of a first wireless access technology. For example, at the time of data transmission, the baseband processor 12-20 may generate complex symbols by encoding and modulating a transmission bitstream. In addition, at the time of data reception, the baseband processor 12-20 reconstructs a reception bit stream by demodulating and decoding a baseband signal provided from the RF processor 12-10. For example, in a case where an OFDM scheme is applied, when data is transmitted, the baseband processor 12-20 may generate complex symbols by encoding and modulating a transmission bitstream, map the complex symbols to subcarriers, and then configure OFDM symbols through IFFT calculation and CP insertion. In addition, when data is received, the baseband processor 12-20 may divide a baseband signal provided from the RF processor 12-10, by the units of OFDM symbols, reconstruct signals mapped to subcarriers, through FFT, and then reconstruct a reception bit stream through demodulation and decoding. The baseband processor 12-20 and the RF processor 12-10 may transmit and receive a signal as described above. Accordingly, the baseband processor 12-20 and the RF processor 12-10 may be called a transmitter, a receiver, a transceiver, a communication unit, or a wireless communication unit.

The communication unit 12-30 may provide an interface for performing communication with other nodes within a network. That is, the backhaul communication unit 12-30 may convert, into a physical signal, a bit stream transmitted from a main base station to another node, for example, an auxiliary base station, a core network, etc., and may convert a physical signal received from another node, into a bit stream. The communication unit 12-30 may be a backhaul communication unit.

The storage unit 12-40 may store data such as a basic program, an application program, and configuration information for an operation of the main base station. Particularly, the storage unit 12-40 may store information on a bearer assigned to a connected terminal, a measurement result reported from a connected terminal, etc. In addition, the storage unit 12-40 may store information serving as a determination criterion of whether to provide or stop providing multi-connection to a terminal. The storage unit 12-40 may provide stored data according to a request of the controller 12-50. The storage unit 12-40 may provide stored data according to a request of the controller 12-50. The storage unit 12-40 may be configured by a storage medium such as a ROM, a RAM, a hard disk, a CD-ROM, and a DVD, or a combination of storage mediums. In addition, the storage unit 12-40 may be configured by a plurality of memories. According to an embodiment, the storage unit 12-40 may store a program for performing a method of transmitting UE assistance information by a terminal supporting multiple USIMs described above.

The controller 12-50 controls overall operations of the base station. For example, the controller 12-50 may transmit or receive a signal via the baseband processor 12-20 and the RF processor 12-10, or via the backhaul communication unit 12-30. In addition, the controller 12-50 may record and read data in and from the storage unit 12-40. To this end, the controller 12-50 may include at least one processor. In addition, at least one element in the base station may be implemented as a single chip. In addition, each element of the base station may operate to perform embodiments of the disclosure. In addition, according to an embodiment of the disclosure, the controller 12-50 may include a multi-connection processor 12-52 that performs processing for operation in a multi-connection mode.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. A method performed by a terminal of a wireless communication system, the method comprising:
receiving, from a base station, a first medium access control (MAC) control element (CE) for indicating activation or deactivation of packet data convergence protocol (PDCP) duplication for one or more data radio bearers (DRBs); and
determining whether to activate or deactivate the PDCP duplication for the one or more DRBs, based on a value of bits included in the first MAC CE,
wherein, in case that a DRB is configured with N unacknowledged mode (UM) radio link control (RLC) entities for a same direction, 2*N UM RLC entities including N UM RLC entities for each direction, or N acknowledged mode (AM) RLC entities, the first MAC CE is not used, and
wherein N is an integer satisfying 2<N<=4.

17. The method of claim 16, wherein the DRB is one of the one or more DRBs.

18. The method of claim 16, wherein, in case that the first MAC CE is not used, a second MAC CE different from the first MAC CE is used to indicate activation or deactivation of the PDCP duplication for the one or more DRBs.

19. The method of claim 18, wherein the second MAC CE is for indicating activation or deactivation of PDCP duplication for an associated RLC entity of the DRB.

20. A method performed by a base station of a wireless communication system, the method comprising:
determining whether to activate or deactivate packet data convergence protocol (PDCP) duplication for one or more data radio bearers (DRBs) with respect to a terminal; and
transmitting, to the terminal, a first medium access control (MAC) control element (CE) for indicating activation or deactivation of the PDCP duplication for the one or more DRBs,
wherein whether to activate or deactivate the PDCP duplication for the one or more DRBs is based on a value of bits included in the first MAC CE,
wherein, in case that a DRB is configured with N unacknowledged mode (UM) radio link control (RLC) entities for a same direction, 2*N UM RLC entities including N UM RLC entities for each direction, or N acknowledged mode (AM) RLC entities, the first MAC CE is not used, and
wherein N is an integer satisfying 2<N <=4.

21. The method of claim 20, wherein the DRB is one of the one or more DRB.

22. The method of claim 20, wherein, in case that the first MAC CE is not used, a second MAC CE different from the first MAC CE is used to indicate activation or deactivation of the PDCP duplication for the one or more DRBs.

23. The method of claim 22, wherein the second MAC CE is for indicating activation or deactivation of PDCP duplication for an associated RLC entity of the DRB.

24. A terminal of a wireless communication system, the terminal comprising:
a transceiver; and
a controller connected to the transceiver,
wherein the controller is configured to:
receive, from a base station, a first medium access control (MAC) control element (CE) for indicating activation or deactivation of packet data convergence protocol (PDCP) duplication for one or more data radio bearers (DRBs); and
determine whether to activate or deactivate the PDCP duplication for the one or more DRBs, based on a value of bits included in the first MAC CE, and
wherein, in case that a DRB is configured with N unacknowledged mode (UM) radio link control (RLC) entities for a same direction, 2*N UM RLC entities including N UM RLC entities for each direction, or N acknowledged mode (AM) RLC entities, the first MAC CE is not used, and
wherein N is an integer satisfying 2<N <=4.

25. The terminal of claim 24, wherein the DRB is one of the one or more DRBs.

26. The terminal of claim 24, wherein, in case that the first MAC CE is not used, a second MAC CE different from the first MAC CE is used to indicate activation or deactivation of the PDCP duplication for the one or more DRBs.

27. The terminal of claim 226, wherein the second MAC CE is for indicating activation or deactivation of PDCP duplication for an associated RLC entity of the DRB.

28. A base station of a wireless communication system, the base station comprising:
a transceiver; and
a controller connected to the transceiver,
wherein the controller is configured to:
determine whether to activate or deactivate packet data convergence protocol (PDCP) duplication for one or more data radio bearers (DRBs) with respect to a terminal; and
transmit, to the terminal, a first medium access control (MAC) control element (CE) for indicating activation or deactivation of the PDCP duplication for the one or more DRBs,
wherein whether to activate or deactivate the PDCP duplication for the one or more DRBs is based on a value of bits included in the first MAC CE,
wherein, in case that a DRB is configured with N unacknowledged mode (UM) radio link control (RLC) entities for a same direction, 2*N UM RLC entities including N UM RLC entities for each direction, or N acknowledged mode (AM) RLC entities, the first MAC CE is not used, and
wherein N is an integer satisfying 2<N <=4.

29. The base station of claim 28, wherein the DRB is one of the one or more DRB.

30. The base station of claim 28, wherein, in case that the first MAC CE is not used, a second MAC CE different from the first MAC CE is used to indicate activation or deactivation of the PDCP duplication for the one or more DRBs.

31. The base station of claim 30, wherein the second MAC CE is for indicating activation or deactivation of PDCP duplication for an associated RLC entity of the DRB.
